(19) United States
(12) Patent Application Publication
(10) Pub. No.: US 2016/0218945 A1
(43) Pub. Date: Jul. 28, 2016

(54) MONITORING APPARATUS, SYSTEM, CONTROL METHOD FOR MONITORING APPARATUS, CONTROL METHOD FOR SYSTEM, AND PROGRAM

(71) Applicant: CANON KABUSHIKI KAISHA, Tokyo (JP)

(72) Inventor: Akiko Hirahara, Kawasaki-shi (JP)

(21) Appl. No.: 14/987,564

(22) Filed: Jan. 4, 2016

(30) Foreign Application Priority Data
Jan. 22, 2015 (JP) 2015-010086

(51) Int. Cl. H04L 12/26

(52) U.S. Cl. CPC H04L 43/065; H04L 43/10

(57) ABSTRACT

A slave apparatus performs, in accordance with reception from a master apparatus a search request in accordance with a state in which a device as a monitoring target of a different apparatus has become unable to be monitored, search processing for a device as a monitoring target of the slave apparatus. When a device which has become unable to be monitored is found, the slave apparatus registers the device as a monitoring target and starts monitoring processing for the device. After starting the monitoring processing, the slave apparatus notifies the master apparatus of the registration of the device, and transmits a result of the monitoring of the device as the monitoring target to a central management apparatus.

### BACKGROUND OF THE INVENTION

1. Field of the Invention

The present invention relates to a technique for a monitoring apparatus to monitor a network device.

2. Description of the Related Art

Device management systems for remotely monitoring an operational status of a device, for example, an image forming device such as a printer or a multifunction device (hereinafter, an image forming device or the like may be simply referred to as a device) have been available. In the device management system, a monitoring apparatus installed on a customer side is connected to a central management apparatus via the Internet. The management apparatus transmits, using a network protocol such as Hypertext Transfer Protocol Secure (HTTPS) or Simple Mail Transfer Protocol (SMTP), collected information/data of a monitoring target device to the central management apparatus, and the central management apparatus executes centralized management. The central management apparatus executes centralized management of customer information, monitoring apparatus information, monitoring target device information and the like for which a maintenance contract is concluded, and stores transmitted data when monitoring information is transmitted from a registered monitoring apparatus.

In the case where a monitoring device on a customer side is present on multiple subnets, multiple monitoring apparatuses may be required. In this case, a monitoring target device may move from a subnet to a different subnet, and a change to a monitoring apparatus that is able to communicate with the device may be required, depending on the network configuration.

As a technique for changing a monitoring apparatus, for example, Japanese Patent Laid-Open No. 2012-203620 has been suggested.

According to the technique disclosed in Japanese Patent Laid-Open No. 2012-203620, when a monitoring apparatus (N-th management apparatus) detects a new device, the monitoring apparatus notifies a central management apparatus (management center server) of the detection of the new device. As a response to the detection of the new device by the monitoring apparatus, the central management apparatus sends a management request to enable the new monitoring apparatus to start monitoring. Furthermore, the central management apparatus may require the original monitoring apparatus to be excluded from a management target by regular polling, so that monitoring by the original monitoring apparatus can be stopped.

However, in Japanese Patent Laid-Open No. 2012-203620, detection of a moved monitoring target device by a new monitoring apparatus is used as a trigger, monitoring may be stopped for a long period of time, depending on the timing for searching for the monitoring target device. Furthermore, a case where multiple monitoring apparatuses are able to communicate with the same device, such as the case where multiple monitoring apparatuses are present on the same subnet, cannot be dealt with.

### SUMMARY OF THE INVENTION

A third apparatus in a system according to an embodiment of the present invention which includes a first apparatus, a second apparatus for monitoring network devices and communicate with a central management apparatus via a network, includes a reception unit configured to receive a search request, in accordance with a state in which a network device as a monitoring target of the second apparatus has become unable to be monitored, from the first apparatus, which manages the second apparatus and the third apparatus; an execution unit configured to execute search processing for a network as a monitoring target of the third apparatus in accordance with the reception of the search request; a registration unit configured to register the network device as a monitoring target when the network device which has become unable to be monitored is found in accordance with the executed search processing; a monitoring unit configured to start monitoring processing for the network device in accordance with the registration of the network device; a notification unit configured to notify the first apparatus of the registration of the network device after the monitoring processing is started; and a transmission unit configured to transmit a result of the monitoring of the network device as the monitoring target to the central management apparatus.

Further features of the present invention will become apparent from the following description of exemplary embodiments with reference to the attached drawings.

### BRIEF DESCRIPTION OF THE DRAWINGS

FIG. 1 is a diagram illustrating a schematic configuration of the entire device management system according to an embodiment.

FIG. 2 is a diagram illustrating a hardware configuration of a central management apparatus and a master/slave monitoring apparatus.

FIG. 3 is a diagram illustrating a hardware configuration of an image forming device.

FIG. 4 is a diagram illustrating a software configuration of a master monitoring apparatus.

FIG. 5 is a diagram illustrating a software configuration of a slave monitoring apparatus.

FIG. 6 is a diagram illustrating a software configuration of an image forming device.

FIG. 7 is a diagram illustrating a software configuration of a central management apparatus.

FIGS. 8A and 8B are flowcharts illustrating an operation of a slave monitoring apparatus.

FIG. 9 is a flowchart illustrating device search processing.

FIG. 10 is a flowchart illustrating device registration processing according to a first embodiment.

FIGS. 11A1 and 11A2 are main flowcharts illustrating an operation of a master monitoring apparatus.

FIGS. 11B and 11C are main flowcharts illustrating an operation of a master monitoring apparatus.

FIGS. 12A and 12B are flowcharts illustrating device information update processing.

FIGS. 13A and 13B are flowcharts illustrating device information change confirmation processing.

FIG. 14 is a diagram illustrating a device management table on a slave monitoring apparatus side.

FIG. 15 is a diagram illustrating a device management table on a master monitoring apparatus side.

FIG. 16 is a diagram illustrating a slave monitoring apparatus management table on a mater monitoring apparatus side.

FIG. 17 is a flowchart illustrating regular search processing according to a second embodiment.

FIG. 18 is a flowchart illustrating device registration processing according to the second embodiment.

FIG. 19 is a flowchart illustrating monitoring target device list acquisition processing.

FIGS. 20A and 20B are diagrams illustrating a user interface (UI) of a mater monitoring apparatus.

### DESCRIPTION OF THE EMBODIMENTS

### First Embodiment

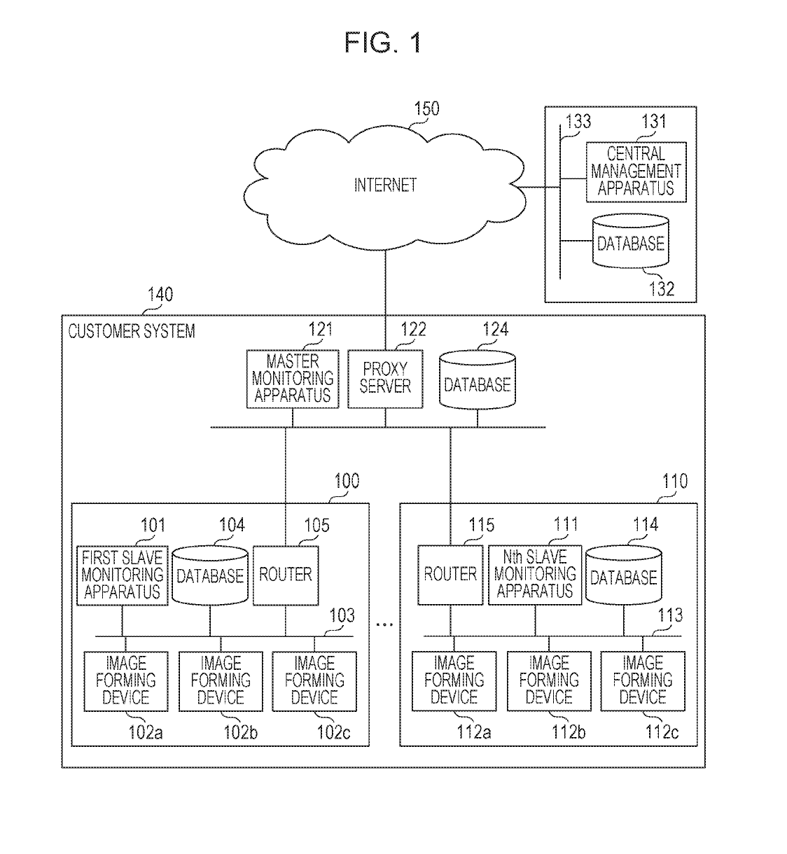

FIG. 1 is a diagram illustrating a schematic configuration of the entire device management system according to an embodiment of the present invention.

As illustrated in FIG. 1, in a device management system according to a first embodiment, multiple customers (not illustrated in FIG. 1) typified by a customer system 140 and a central management apparatus 131 are connected. Furthermore, normally, a sales company system and the like are also connected to the device management system. However, such systems are not directly related to the present invention, and therefore not illustrated here.

In the customer system 140, multiple subnets exist. A single master monitoring apparatus 121 and multiple slave monitoring apparatuses 101 and 111 monitor devices (network devices) on individual subnets. Information that the slave monitoring apparatuses acquire from devices (102a to 102c, 112a to 112c, etc.) is transmitted to a central management apparatus 131 and stored in a database 132. The database 132 is a history storing unit that stores information for monitoring, counters for image forming devices collected from customers, failure history information, failure pattern tables, and the like. The system according to this embodiment includes the master monitoring apparatus 121 and the multiple slave monitoring apparatuses 101 and 111 that are able to monitor network devices such as the image forming devices 102 and 112 and the like and communicate with the central management apparatus 131 via a network.

The central management apparatus 131 and the database 132 are connected by a local area network (LAN) 133. The LAN 133 is able to be connected to the Internet 150. The database 132 may physically exist within the central management apparatus 131. Furthermore, if access from the central management apparatus 131 is possible, the database 132 may exist in a different place via the Internet 150. The central management apparatus 131 has a function to collect, store, and process information of the image forming devices (102 and 112) as monitoring targets and information (including failure information) indicating the operational status from the slave monitoring apparatuses 101 and 111 and provide warnings and the like to the outside. The central management apparatus 131 also has a function to distribute the above information to, for example, sales companies.

The operational statuses of the image forming devices 102 and 112 include, for example, running out of toner, door opening, drum replacement, absence of a cartridge, abnormality of a cooling fan, abnormality of a substrate, contamination of platen glass, running out of staples, shortage of the light amount of a paper feed sensor, and the like. Furthermore, the operational statuses also include font memory overflow, rendering error, abnormality of a fixing device, abnormality of a counter, abnormality of a double-sided unit, paper, jam, and the like. Furthermore, as counter information, a charging counter as a charging target for a sales company, a department counter calculated for each department of a customer, a size counter calculated for each paper size, a part counter indicating the consumed level of parts within the image forming devices 102 and 112, and the like.

In this embodiment, as an example of a device (network device) that the single master monitoring apparatus 121 and the multiple slave monitoring apparatuses 101 and 111 monitor, an image forming device will be described. However, a device (network device) according to this embodiment is not limited to an image forming device such as a copying machine, a printer, a scanner, or a multifunction device. The device may be a computer, a digital medical device, a network camera, a network home electronic appliance, a robot, or the like.

Furthermore, information of an image forming device as a monitoring target of the central management apparatus 131 and settings for monitoring may be registered in the central management apparatus 131. The central management apparatus 131 may merge and collectively manage the registered settings for the image forming device as the monitoring target and monitoring. Furthermore, the central management apparatus 131 may perform settings regarding monitoring for the master monitoring apparatus 121 and the slave monitoring apparatuses 101 and 111.

A service by the device management system according to this embodiment is provided based on a maintenance contract concluded between a sales company and a customer. Therefore, only an image forming device determined to be a monitoring target based on the contract by the sales company is defined as a monitoring target of the device management system.

In FIG. 1, only a single central management apparatus 131 and a single database 132 are illustrated. In actuality, however, in order to achieve load balancing of information collection and firmware distribution from a large number of image forming devices and slave/master monitoring apparatuses, multiple central management apparatuses and databases may perform processing in a distributed manner.

Next, a customer-side system configuration will be described.

There are a plurality of different customer environments. In FIG. 1, the customer system 140 is illustrated.

The customer system 140 corresponds to a system of a certain customer and is a configuration example that establishes a large-scale network. The multiple slave monitoring devices 101 and 110 are arranged in the customer system 140. Due to limited space in FIG. 1, only three devices 102a to 102c and 112a to 112c are illustrated as the image forming devices 102 and 112 as monitoring targets. In actuality, however, in a large-scale environment, several hundred to several thousand devices are monitored by a device management program installed in a general-purpose personal computer (PC). Normally, a single slave monitoring apparatus is arranged on a single subnet. However, in a larger-scale environment, multiple slave monitoring apparatuses may be arranged on a single subnet.

Hereinafter, a customer system 100 will be described in detail.

In the customer system 100, the image forming devices 102a, 102b, and 102c that are connected to a LAN 103 connected to the Internet 150 are monitored by the slave monitoring apparatus 101. Similarly, in a customer system 110, the image forming devices 112a, 112b, and 112c that are connected to a LAN 113 connected to the Internet 150 are monitored by the slave monitoring apparatus 111.

The slave monitoring apparatuses 101 and 111 communicate with the master monitoring apparatus 121. The slave monitoring apparatuses 101 and 111 and the master monitoring apparatus 121 communicate with the central management apparatus 131 via the Internet 150 through a proxy server 122.

An HTTP(S)/SOAP protocol may be utilized for communication among the above slave monitoring apparatuses 101 and 111, the master monitoring apparatus 121, the central management apparatus 131, and the image forming devices 102 and 112. SOAP is the abbreviation for a Simple Object Access Protocol. SOAP is a protocol for allowing a computer to call data and services of a different computer, based on eXtended Markup Language (XML). In this embodiment, SOAP is implemented on HTTP(S). Communication using the SOAP exchanges an SOAP message in which additional information is added to an XML document. Therefore, a computer which supports the SOAP includes an SOAP message generation unit that generates an SOAP message and an SOAP message interpretation unit that interprets the SOAP message. In this embodiment, status information of an image forming device is transmitted to the central management apparatus 131 by an SOAP message. Furthermore, although the SOAP is used in this embodiment, it is obvious that other IFs/protocols including Representational State Transfer (REST) may be used in a similar manner.

The slave monitoring apparatus 101 stores information collected from the image forming devices 102a, 102b, and 102c and processing results of the collected data into a database 104. Furthermore, the slave monitoring apparatus 101 stores settings regarding monitoring of the image forming devices 102a, 102b, and 102c into the database 104 or a storage device built in the slave monitoring apparatus 101. Furthermore, the slave monitoring apparatus 101 stores status information (for example, generation of a failure etc.) of the image forming devices 102a, 102b, and 102c into the database 104 every time receiving the status information from the image forming devices 102a, 102b, and 102c, and transmits the status information to the central management apparatus 131. In this embodiment, the slave monitoring apparatus 101 is configured to transmit data regarding device monitoring directly to the central management apparatus 131. However, the slave monitoring apparatus 101 may be configured to transmit a part or all of the monitoring data to the master monitoring apparatus 121 once. The slave monitoring apparatus 111 is configured in a similar manner, and explanation for the slave monitoring apparatus 111 will be omitted.

The master monitoring apparatus 121 has a role to control multiple slave monitoring apparatuses. Specifically, the master monitoring apparatus 121 issues an instruction to each slave monitoring apparatus and an instruction regarding a monitoring target device, and responds to requests to acquire various types of information from a slave monitoring apparatus. The slave monitoring apparatus 121 stores information collected from the slave monitoring apparatuses 101 and 111 and processing results of various requests into a database 124.

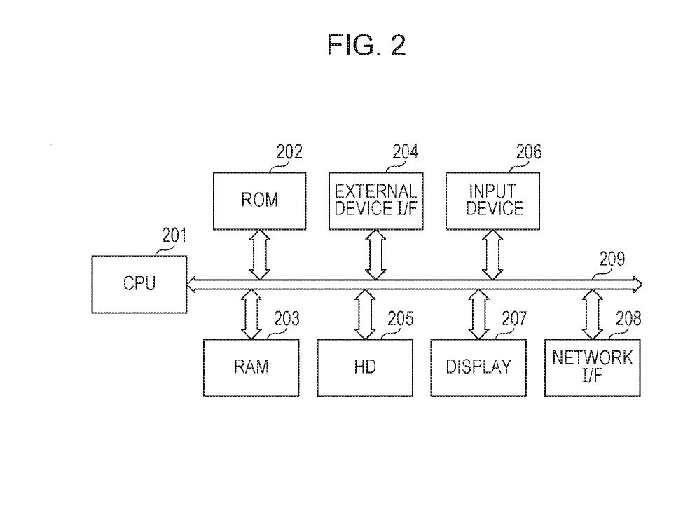

FIG. 2 is a block diagram illustrating a hardware configuration of an information processing apparatus which may be applied to the slave monitoring apparatuses 101 and 111, the master monitoring apparatus 121, the central management apparatus 131, a host terminal, and the like. This configuration may also be applied to an information processing apparatus installed at a back end, which is not illustrated in the figure.

Referring to FIG. 2, a central processing unit (CPU) 201 is a controller of the information processing apparatus. The CPU 201 executes an application program, a printer driver program, an operating system (OS), a device management program according to this embodiment, and the like which are stored in a hard disk (HD) 205. Furthermore, although only one CPU is used in this embodiment, a plurality of CPUs may be used.

A read only memory (ROM) 202 is a non-rewritable storage device. The ROM 202 stores a basic I/O program, a program which manages each process of the apparatus, and data. A random access memory (RAM) 203 functions as a main memory, a work area, and the like of the CPU 201. The CPU 201 performs control for temporarily storing information, a file, and the like for execution of a program into the RAM 203. Processing of each step of the slave monitoring apparatuses 101 and 111 in each flowchart described later is implemented when the CPU 201 performs processing based on a program code stored in a storage device such as an external storage device, the HD 205, or the like which is connected via an external device I/F 204.

The external device I/F 204 allows connection with an external storage device and the like. By connection with an external storage device, a program or the like stored in the external storage device may be loaded into the information processing apparatus. A storage medium used for the external storage device may be any type including a flexible disk (FD), a compact disc-read only memory (CD-ROM), a compact-disc recordable (CD-R), a compact disc-rewritable (CD-RW), a personal computer (PC) card, a digital versatile disk (DVD), an IC memory card, a magneto-optical disk (MO), and a memory stick.

The HD 205 stores a program and data regarding each process of the apparatus, temporary data, information regarding an image forming device as a monitoring target in an embodiment of the present invention, and various data such as data collected from the image forming device. In this configuration example, only one HD is used. However, a plurality of HDs may be used. Furthermore, apart from an HD, other types of storage devices including a solid state drive (SSD) may be used.

An input device 206 as an instruction input unit includes, for example, a keyboard, a pointing device, and the like. A user of the system, such as a serviceman, an operator, or an administrator, performs an input instruction for settings, operations, and the like to the information processing apparatus through the input device 206.

A display 207 as a display unit displays an instruction input through the input device 206 and the status and settings of the image forming device as a management target. In actuality, information which is obtained by converting a rendering command which has been issued by an application using a mechanism of an OS and interpreted by a graphic card into an analog signal or a digital signal may be displayed on the display 207. Display control mentioned in this embodiment includes processing for causing generation of a rendering command through an OS so that information may be displayed on the display 207.

A network I/F 208 is a network interface which is connected to a LAN and the Internet via a network to perform information exchange with the outside. The information processing apparatus exchanges data with an external device via the network I/F 208. A system bus 209 manages the flow of data of the above elements (201 to 208) in the information processing apparatus.

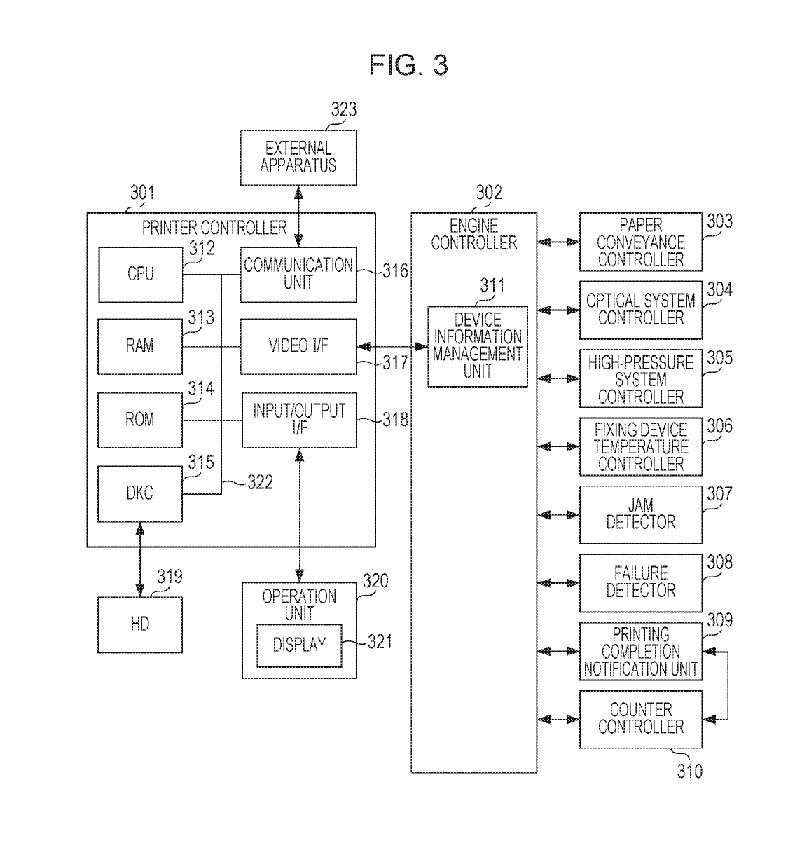

FIG. 3 is a diagram illustrating a configuration of the image forming devices 102 and 112.

Referring to FIG. 3, a printer controller 301 includes a CPU 312, a RAM 313, a ROM 314, a disk controller (DKC) 315, a communication unit 316, a video I/F 317, an input/output I/F 318, and the like.

The CPU 312 controls access to various devices connected to a system bus 322, based on a control program or the like stored in the ROM 314 or an HD (external memory) 319, in an integrated manner. Furthermore, the CPU 312 outputs an image signal as output information to a printer engine connected via the video I/F 317. The RAM 313 functions as a main memory, a work area, and the like of the CPU 312.

The DKC 315 controls access to the external storage medium 319 such as a hard disk (HD) which stores a boot program, various applications, font data, a user file, a setting file, and the like.

The communication unit 316 performs transmission and reception of various data to and from an external apparatus 323 (the slave monitoring apparatuses 101 and 110 in FIG. 1, etc.) such as a host computer, using a predetermined protocol.

The video I/F 317 develops image data into information that may be printed by a printer and performs exchange and serial communication of signals with an engine controller 302, which will be described later.

An operation unit 320 includes an input part such as a display 321 and a keyboard. The operation unit 320 provides information to an operator and allows the operator to input instructions via the input/output I/F 318.

The engine controller 302 controls each unit of the printer engine through exchange of signals and serial communication with the printer controller 301. A paper conveyance controller 303 executes feeding and conveyance of paper on which printing is to be performed and conveyance of paper to be discharged after printing is finished, based on an instruction by the engine controller 302. An optical system controller 304 executes driving of a scanner motor and ON/OFF control of a laser, based on an instruction by the engine controller 302.

A high-pressure system controller 305 outputs high pressure for an electrophotographic process such as charging, developing, and transfer, in accordance with an instruction by the engine controller 302. A fixing device temperature controller 306 controls the temperature of a fixing device, based on an instruction by the engine controller 302, and performs detection of abnormality of the fixing device, and the like. A jam detector 307 detects a conveyance defect in the conveyance of paper. A failure detector 308 detects a failure in a function unit of the printer. A printing completion notification unit 309 detects that printing has been normally completed and notifies the engine controller 302 of the completion of printing. A counter controller 310 updates information of various counters such as a charging counter and a part counter, after printing is completed.

The engine controller 302 includes a device information management unit 311 that manages information of each unit of the printer engine. The device information management unit 311 acquires, for example, various counters from the counter controller 310, in accordance with a request from the external apparatus 323, and delivers the acquired various counters to the video I/F 317. Accordingly, the counter information is transmitted to the external apparatus 323 via the video I/F 317 and the communication unit 316. Also in the case where an information acquisition request is received from the external apparatus 323, the device information management unit 311 acquires information from each unit. Furthermore, jam information notified from the jam detector 307 and error information notified from the failure detector 308 are also managed by the device information management unit 311. In the case where an event notification request is received from the external apparatus 323 in advance, alarm and error information are transmitted to the external apparatus 323 via the video I/F 317 or the like.

Furthermore, it is obvious that the above configuration is applicable to a laser beam printer which utilizes the above-mentioned electrophotographic method, an inkjet printer which utilizes an inkjet method, a thermal head printer which adopts a thermal transfer method, a copying machine, and the like as image forming devices according to an embodiment of the present invention.

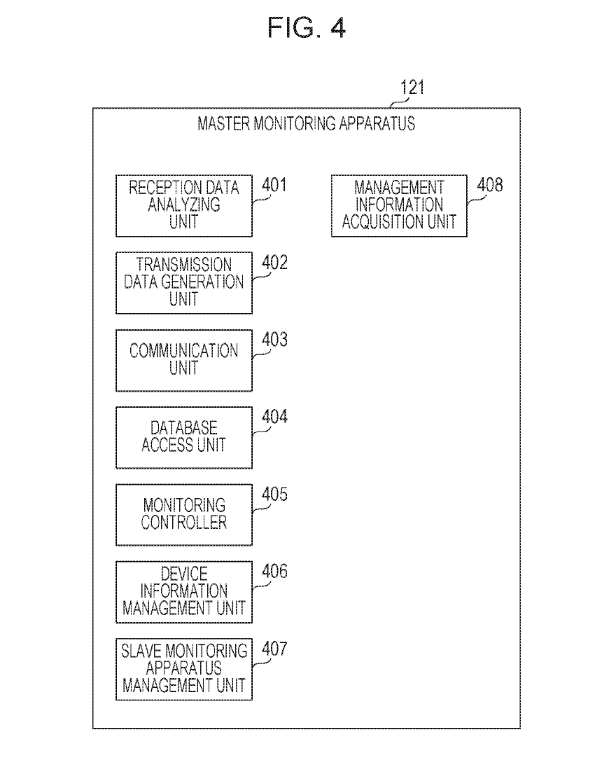

FIG. 4 is a diagram illustrating a software configuration in the master monitoring apparatus 121. Individual units illustrated in FIG. 4 are implemented when the CPU 201 of the master monitoring apparatus 121 reads and executes a program stored in the ROM 202, the HD 205, or the like.

Referring to FIG. 4, a reception data analyzing unit 401 analyzes reception data received from the central management apparatus 131 and the slave monitoring apparatuses 101 and 111 via a communication unit 403, and delivers the reception data to an appropriate processing unit for each data.

A transmission data generation unit 402 generates transmission data corresponding to a communication protocol, in response to a request from each processing unit. The generated transmission data is transmitted to the slave monitoring apparatuses 101 and 111 and the central management apparatus 131 via the communication unit 403.

The communication unit 403 performs transmission and reception of data to and from an external information processing apparatus such as the slave monitoring apparatuses 101 and 111 and the central management apparatus 131 via a network such as a LAN and the Internet.

A database access unit 404 controls input and output to the database 124. Furthermore, in the case where data such as monitoring data and setting data is stored in a storage device or the like which is built in the master monitoring apparatus 121, the database access unit 404 manages input and output to the storage device.

A monitoring controller 405 issues instructions and perform control for the slave monitoring apparatuses 101 and 111, based on information acquired from a device information management unit 406, a slave monitoring apparatus management unit 407, and the like.

The device information management unit 406 manages information of an image forming device as a monitoring target registered in the central management apparatus 131 and device information acquired from the slave monitoring apparatuses 101 and 111. The device information management unit 406 stores the above various types of information into the database 124 via the database access unit 404.

The slave monitoring apparatus management unit 407 manages communication address information of a slave monitoring apparatus that the master monitoring apparatus 121 manages, a monitoring apparatus ID which identifies the monitoring apparatus, and the like.

A management information acquisition unit 408 acquires information of the slave monitoring apparatuses 101 and 111 that the master monitoring apparatus 121 manages, from the central management apparatus 131. For example, the management information acquisition unit 408 generates, at the transmission data generation unit 402, a request for acquiring a list of monitoring devices that the slave monitoring apparatus 101 is to monitor, and transmits the request to the central management apparatus 131 via the communication unit 403. As a result, the management information acquisition unit 408 acquires the monitoring target device list for the slave monitoring apparatus 101. In this embodiment, an example in which the monitoring target device list is acquired in accordance with an instruction from the monitoring controller 405 is described. However, the management information acquisition unit 408 may operate independently, and the configuration does not matter.

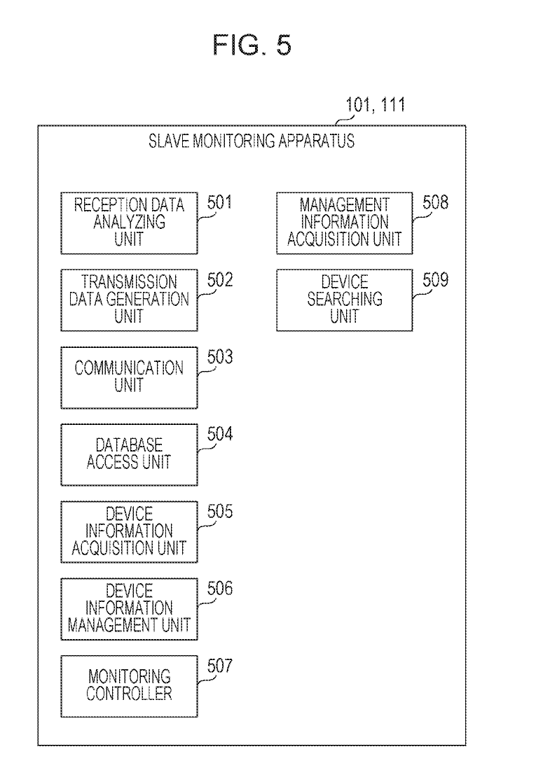

FIG. 5 is a diagram illustrating a software configuration of the slave monitoring apparatuses 101 and 111. Individual units illustrated in FIG. 5 are implemented when the CPU 201 of the slave monitoring apparatuses 101 and 111 reads and executes a program stored in the ROM 202, the HD 205, or the like.

Referring to FIG. 5, a reception data analyzing unit 501 analyzes reception data received from the master monitoring apparatus 121, the central management apparatus 131, and the image forming devices 102 and 112 via a communication unit 503, and delivers the reception data to an appropriate processing unit for each data.

A transmission data generation unit 502 generates transmission data corresponding to a communication protocol in response to a request from each processing unit. The generated transmission data is transmitted to the central management apparatus 131 and the image forming devices 102 and 112 via the communication unit 503.

The communication unit 503 performs transmission and reception of data to and from an external information processing apparatus such as the master monitoring apparatus 121, the central management apparatus 131, the image forming devices 102 and 112, and the like via a network such as a LAN and the Internet.

A database access unit 504 manages input and output to the database 104 and a database 114. Furthermore, in the case where necessary data such as monitoring data and setting data is stored in a storage device or the like which is built in a slave monitoring apparatus, the database access unit 504 manages input and output to the storage device.

A device information acquisition unit 505 acquires device information such as the status and capability information of the image forming devices 102 and 112, information regarding a failure, counter information, log information, and the like from the image forming devices 102 and 112.

A device information management unit 506 registers and manages device information acquired by the device information acquisition unit 505 in association with an image forming device as a monitoring target registered in the central management apparatus 131. The device information management unit 506 also manages management information of each device acquired from the master monitoring apparatus 121. In this embodiment, the slave monitoring apparatuses 101 and 111 are configured to acquire management information of each device from the central management apparatus 131 via the master monitoring apparatus 121. However, the slave monitoring apparatuses 101 and 111 may directly acquire management information from the central management apparatus 131. The device information management unit 506 stores the device information acquired as described above into the databases 104 and 114 via the database access unit 504.

A monitoring controller 507 performs monitoring control processing for a monitoring device. The monitoring controller 507 collects monitoring information via the device information acquisition unit 505 in accordance with a transmission schedule instructed from the master monitoring apparatus 121 or the central management apparatus 131 or a single instruction. The collected monitoring information (including at least one of information regarding a failure, counter information, and log information) is managed by the device information management unit 506, is processed into transmission data by the transmission data generation unit 502 in accordance with the transmission schedule, and is transmitted to the central management apparatus 131 by the communication unit 503. Furthermore, the monitoring controller 507 also adds a monitoring device and processes device event data such as a jam and running out of toner. When a device event is detected or a specific error, such as mismatching of the serial number of a device, occurs, the monitoring controller 507 generates a dummy alarm at the transmission data generation unit 502 and the dummy alarm is transmitted to the central management apparatus 131 by the communication unit 503 in an appropriate manner.

A management information acquisition unit 508 acquires management information of a regular transmission schedule regarding the slave monitoring apparatus, an instruction, and the like from the master monitoring apparatus 121 and the central management apparatus 131. Furthermore, the management information acquisition unit 508 generates, at the transmission data generation unit 502, a request for acquiring a list of monitoring devices that the slave monitoring apparatus is to monitor, and transmits the request to the master monitoring apparatus 121 via the communication unit 503. As a result, the management information acquisition unit 508 acquires the monitoring target device list. In this embodiment, an example in which the management information acquisition unit 508 acquires the monitoring target device list in accordance with an instruction from the monitoring controller 507 is described. However, the management information acquisition unit 508 may operate independently, and the configuration does not matter.

A device searching unit 509 performs device search, based on pinpoint search in which an address is specified within a monitoring area of a slave monitoring apparatus or full search within a monitoring area such as broadcasting or multicasting. For the full search, address specification is performed in advance.

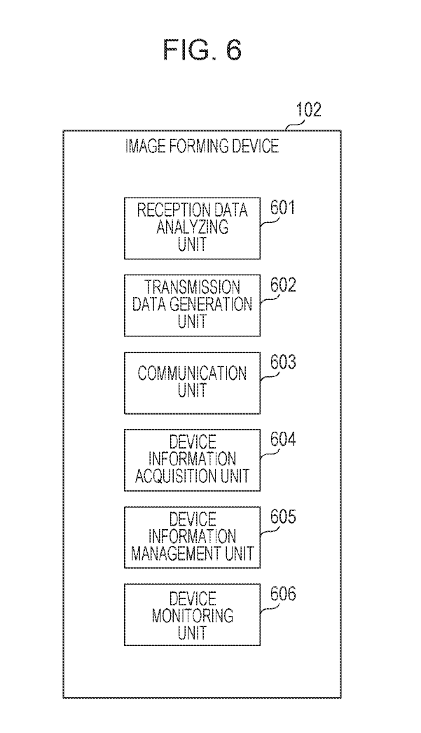

FIG. 6 is a diagram illustrating a software configuration of the image forming devices 102 and 112. Individual units illustrated in FIG. 6 are implemented when the CPU 312 of the image forming devices 102 and 112 reads and executes a program stored in the ROM 314, the HD 319, or the like.

Referring to FIG. 6, a reception data analyzing unit 601 analyzes reception data received from the central management apparatus 131 and the slave monitoring apparatuses 101 and 111 via a communication unit 603, and delivers the reception data to an appropriate processing unit for each data.

A transmission data generation unit 602 generates transmission data corresponding to a communication protocol in response to a request from each processing unit. The transmission data generated by the transmission data generation unit 602 is transmitted to the slave monitoring apparatuses 101 and 111 via the communication unit 603.

The communication unit 603 performs transmission and reception of data to and from an external apparatus such as the slave monitoring apparatuses 101 and 111 via a network such as a LAN and the Internet.

A device information acquisition unit 604 acquires status information of a service call, a jam, and the like generated within the image forming device. Furthermore, the device information acquisition unit 604 acquires counter information and the like held within the image forming device, in accordance with an instruction from the slave monitoring apparatuses 101 and 111. The data acquired by the device information acquisition unit 604 is processed into transmission data at the transmission data generation unit 602, and is transmitted, by the communication unit 603, to an acquisition request source such as the slave monitoring apparatuses 101 and 111 or the like.

A device information management unit 605 manages and controls the device information collected by the device information acquisition unit 604.

A device monitoring unit 606 performs monitoring inside the device when a monitoring function within the device becomes effective, similarly to an external monitoring apparatus. In accordance with a transmission schedule instructed by the slave monitoring apparatuses 101 and 111 or an instruction from an external application, monitoring information is collected by the device information acquisition unit 604. The monitoring information is managed by the device information management unit 605, is processed into transmission data in accordance with the transmission schedule or the external instruction, and is transmitted, by the communication unit 603, to the slave monitoring apparatuses 101 and 111. Furthermore, event data of the device is processed, and is transmitted to the slave monitoring apparatuses 101 and 111 in an appropriate manner.

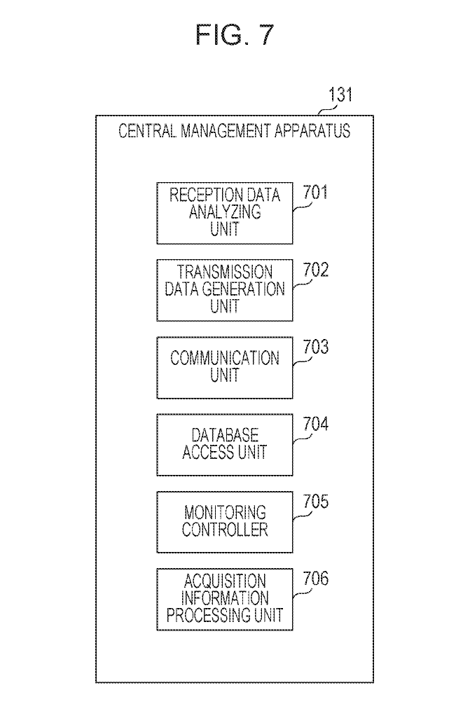

FIG. 7 is a diagram illustrating a software configuration of the central management apparatus 131. Individual units illustrated in FIG. 7 are implemented when the CPU 201 of the central management apparatus 131 reads and executes a program stored in the ROM 202, the HD 205, or the like.

Referring to FIG. 7, a reception data analyzing unit 701 analyzes reception data received from the master monitoring apparatus 121, the slave monitoring apparatuses 101 and 111, and the like via a communication unit 703, and delivers the reception data to an appropriate processing unit for each data.

A transmission data generation unit 702 generates transmission data corresponding to a communication protocol in response to a request from each processing unit. The transmission data generated by the transmission data generation unit 702 is transmitted to the slave monitoring apparatuses 101 and 111 or the like via the communication unit 703.

The communication unit 703 performs transmission and reception of data to and from an external information processing apparatus such as the slave monitoring apparatuses 101 and 111 and the master monitoring apparatus 121 via a network such as a LAN and the Internet.

A database access unit 704 manages input and output to the database 132.

A monitoring controller 705 controls a schedule for acquiring monitoring information, charging information, and the like received from all of the master monitoring apparatus/slave monitoring apparatuses, the monitoring contents, and the monitoring method. The monitoring controller 705 transmits, as necessary, instructions and responses to the master monitoring apparatus 121 and the slave monitoring apparatuses 101 and 111 that the central management apparatus 131 controls, via the transmission data generation unit 702 and the communication unit 703.

An acquisition information processing unit 706 processes or does not process information received from the master monitoring apparatus 121 and the slave monitoring apparatuses 101 and 111 that the central management apparatus 131 controls, and stores the unprocessed or processed information into the database 132 via the database access unit 704. Furthermore, the acquisition information processing unit 706 notifies a serviceman in charge or a customer of calculated results of counter information, error information including a dummy alarm, and the like, based on information received from the master monitoring apparatus 121, the slave monitoring apparatuses 101 and 111, and the like and data stored in the database 132.

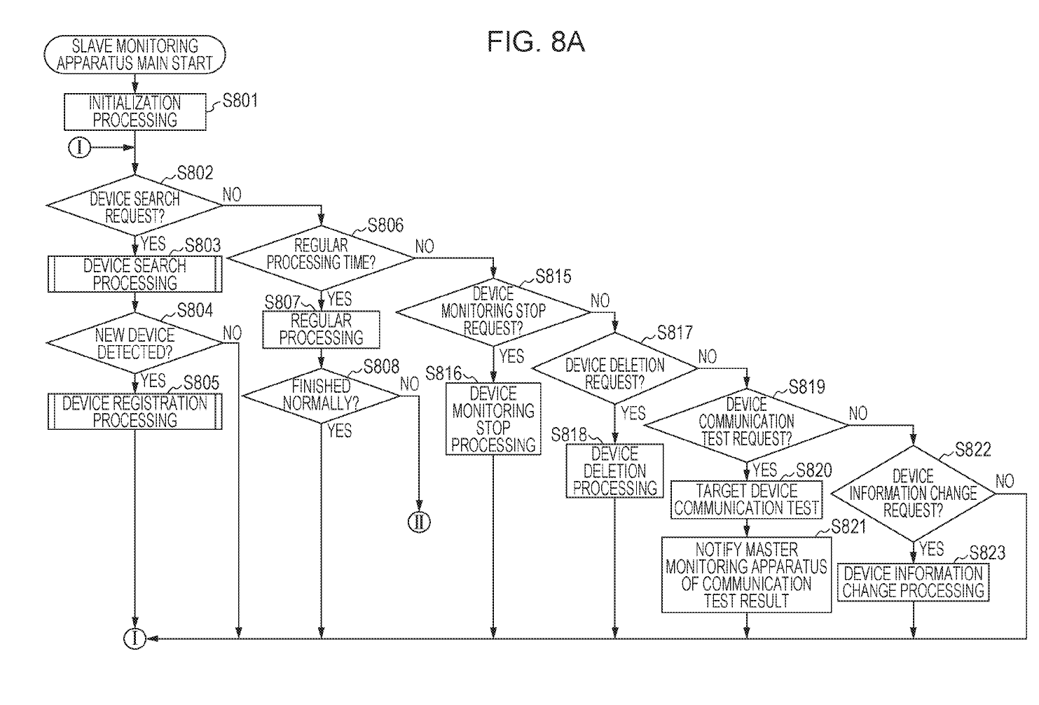

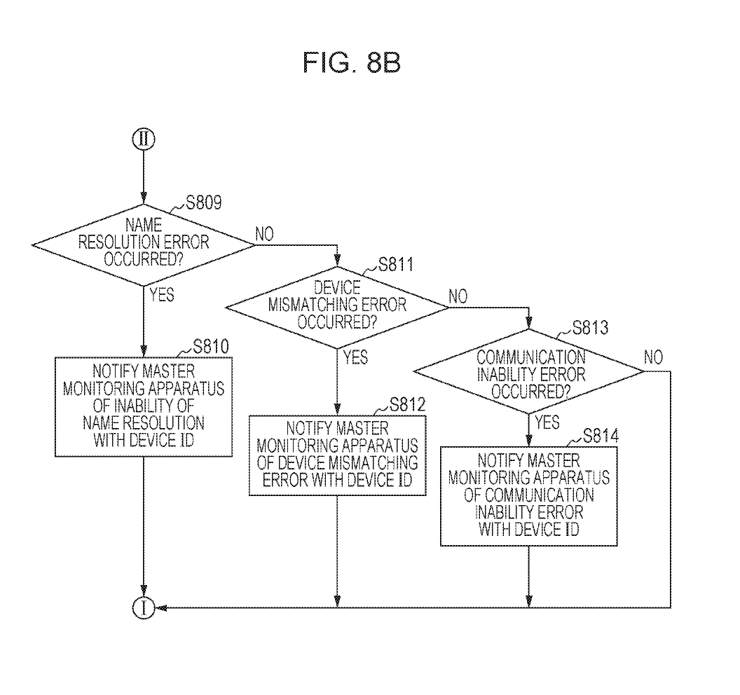

FIGS. 8A and 8B are main flowcharts illustrating an operation of the slave monitoring apparatuses 101 and 111. Hereinafter, for a simpler explanation, an operation of the slave monitoring apparatus 101 within the customer system 140 will be described. However, the explanation provided below is also applied to the slave monitoring apparatus 111. Processing of individual steps illustrated in flowcharts of FIGS. 8 to 10 are implemented when the CPU 201 provided in the slave monitoring apparatus reads and executes a control program according to an embodiment of the present invention stored in a nonvolatile storage device such as the ROM 202 or the HD 205. Furthermore, in the flowcharts, only processing relevant to the present invention will be explained. Since processing not relevant to the present invention is different from the essence of the present invention, explanation for that processing will be omitted. Furthermore, in the explanation provided below, an image forming device will be noted as a monitoring device or simply noted as a device. In addition, unless otherwise stated, the processing is mainly operated by the monitoring controller 507, in cooperation with each unit as necessary.

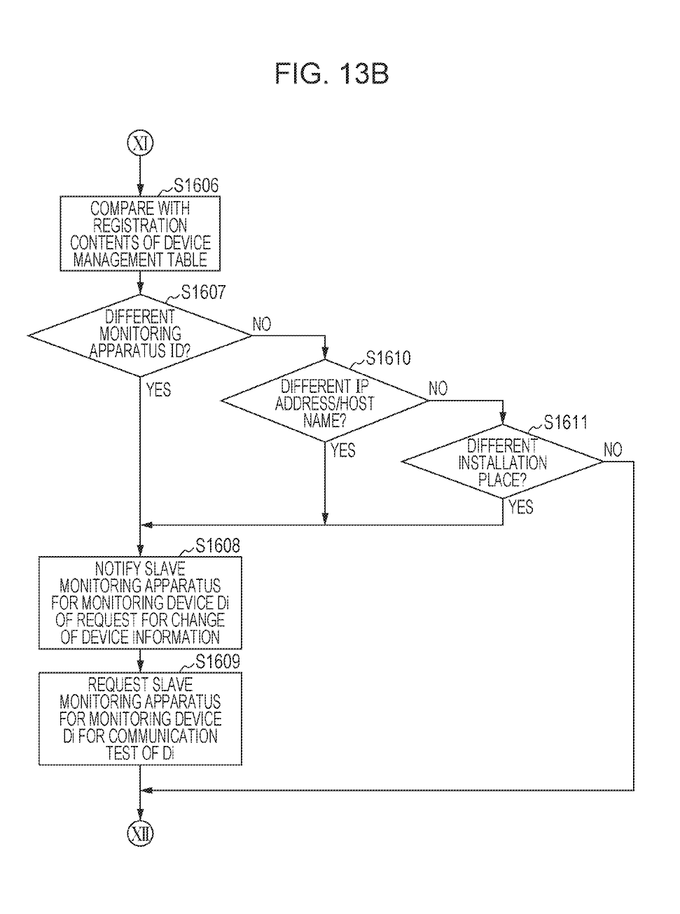

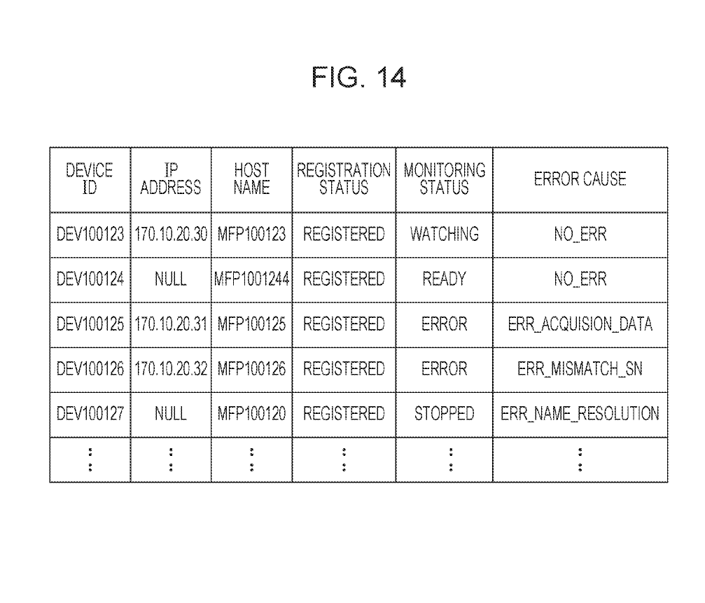

When power is applied to the slave monitoring apparatus, the slave monitoring apparatus first initializes the system in accordance with the application of the power (S801). Specifically, the slave monitoring apparatus performs reading of initial setting information, initialization processing for each operation unit, and the like. For example, the device information management unit 506 accesses a device management table Td (FIG. 14) from the database 104 via the database access unit 504, an reads information for initialization onto a working memory such as the RAM 203. The monitoring controller 507 performs initialization processing for device monitoring for the device management table Td. For example, the monitoring controller 507 also performs event registration and the like to the device.

FIG. 14 is a diagram illustrating the device management table Td. The device management table Td is stored and managed by the database 104.

As illustrated in FIG. 14, the device management table according to this embodiment holds a device ID, an IP address, a host name, a registration status, a monitoring status, an error cause, and the like, as items. Furthermore, device information other than the above items is also included in the device management table. However, such device information is not relevant to the essence of the present invention, and therefore explanation for such device information will be omitted.

The device ID is an ID for uniquely identifying a device. The IP address and the host name are items for identifying the address of the device. Normally, one of the IP address and the host name is specified, and the other is derived by name resolution. Before starting monitoring of the device, the slave monitoring apparatus acquires capability information and the like, as well as information unique to the device such as the product name, the serial number, and the media access control (MAC) address of the device, and performs monitoring corresponding to the capability. In this embodiment, the above series of operations is performed as device registering processing, and the registration status within the device management table represents the status of the registration processing.

The registration status includes ready-for-registration (REGIST READY), registration-in-progress (REGISTERING), registration completed (REGISTERED), and the like. The monitoring status represents the status at the time when a try of communication with the device is made as a part of the monitoring processing, and includes monitoring-in-progress (WATCHING), ready-for-monitoring (READY), error (ERROR), monitoring stopped (STOPPED), and the like. The error cause represents a cause of an error in the monitoring status or a cause of an error to stop monitoring. When no error has occurred, NO₁₃ERR is indicated.

After the initialization processing in step S801 is completed, the monitoring controller 507 enters normal processing.

In S802, the monitoring controller 507 determines whether or not a device search request from the master monitoring apparatus 121 is detected (a device search request from the master monitoring apparatus 121 is received). The device search request represents a search request received from the master monitoring apparatus 121 in accordance with inability of monitoring of a device as a monitoring target of the slave monitoring apparatus 111 (the details will be described later).

Then, when it is determined that a device search request from the master monitoring apparatus 121 is detected (Yes in S802), the monitoring controller 507 proceeds to S803.

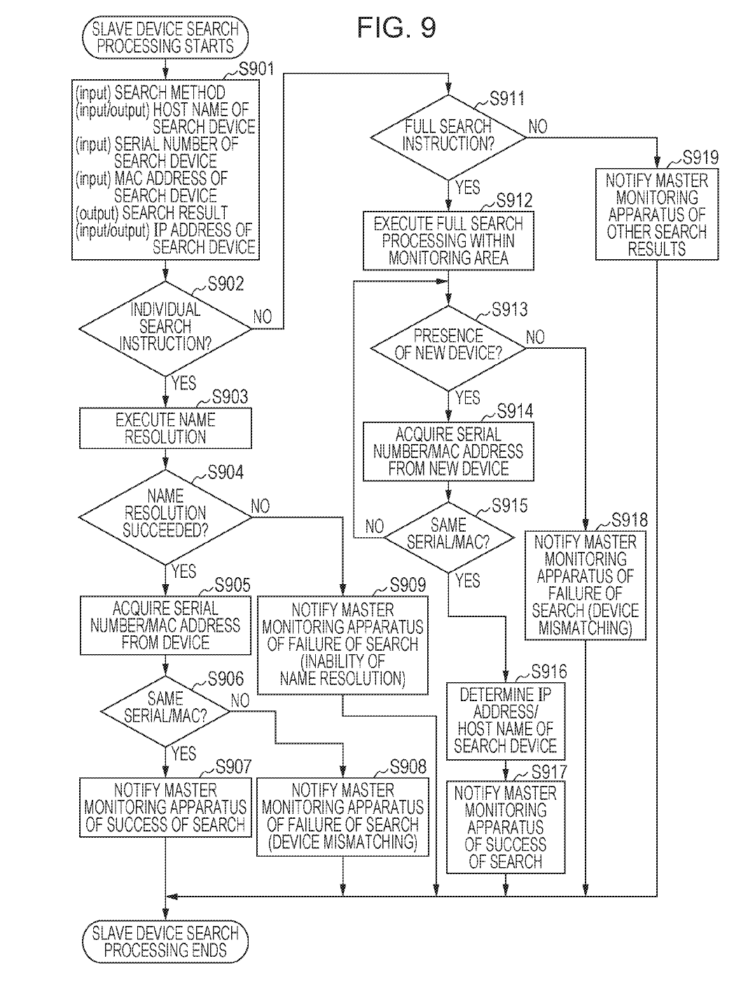

In S803, the monitoring controller 507 performs device search processing. The device search processing will be described in detail with reference to FIG. 9. FIG. 9 will be described later.

When the device search processing in S803 is completed, the monitoring controller 507 determines in S804 whether or not a new device which has not been managed by the slave monitoring apparatus is detected in the device search processing of S803.

When it is determined that a new device which has not been managed by the slave monitoring apparatus is detected (Yes in S804), the monitoring controller 507 proceeds to S805.

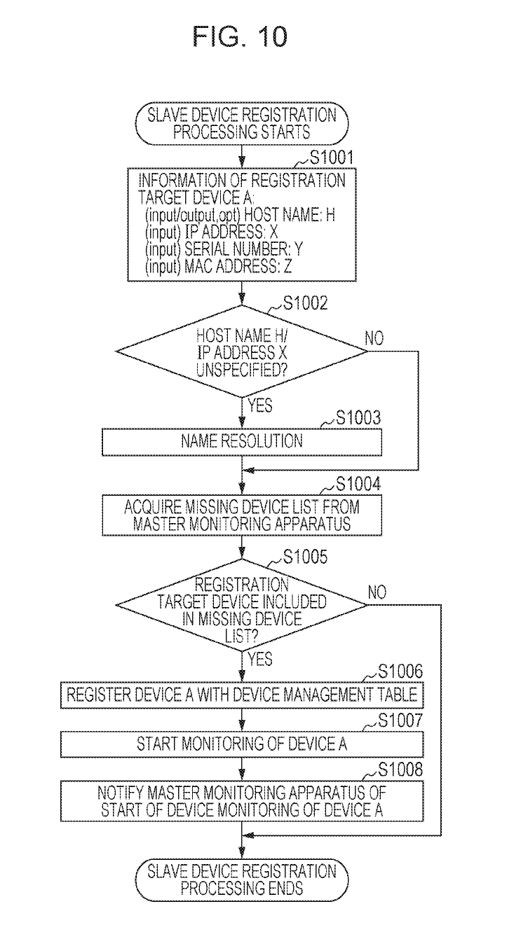

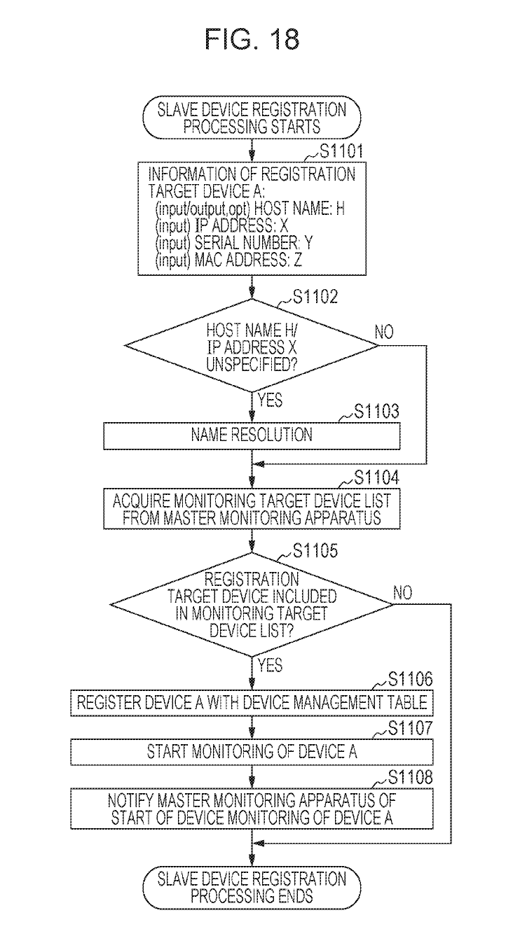

In S805, the monitoring controller 507 requests the management information acquisition unit 508 for device registration processing. The device registration processing will be described in detail with reference to FIGS. 10 and 18. FIG. 10 will be described later. FIG. 18 will be described later in a second embodiment. When the device registration processing in S805 is completed, the monitoring controller 507 proceeds to S802.

When it is determined in S802 that a device search request from the master monitoring apparatus 121 is not detected (No in S802), the monitoring controller 507 proceeds to S806.

In S806, the monitoring controller 507 determines whether or not a regular processing time has been reached. When it is determined that the regular processing time has been reached (Yes in S806), the monitoring controller 507 proceeds to S807.

In S807, the monitoring controller 507 performs regular processing. The regular processing is processing which is performed regularly, such as processing for acquiring various counters, logs, and device statuses in accordance with a schedule. The details of the regular processing are not relevant to the essence of the first embodiment, and therefore explanation for those details will be omitted in the first embodiment.

After the regular processing in S807, the monitoring controller 507 determines whether or not the regular processing is normally finished in S808. When it is determined that the regular processing is normally finished (Yes in S808), the monitoring controller 507 proceeds to S802.

Meanwhile, when it is determined that the regular processing is not normally finished (No in S808), the monitoring controller 507 performs error processing and proceeds to S809.

In S809, the monitoring controller 507 determines whether or not a name resolution error has occurred in the regular processing.

When it is determined that a name resolution error has occurred in the regular processing (Yes in S809), the monitoring controller 507 proceeds to S810.

In S810, the monitoring controller 507 notifies the master monitoring apparatus 121 of a name resolution inability error. At least a device ID for identifying the device in which the error has occurred is added to notification data. After the processing of S810, the monitoring controller 507 proceeds to S802.

Meanwhile, when it is determined in S809 that a name resolution error has not occurred in the regular processing (No in S809), the monitoring controller 507 proceeds to S811.

In S811, the monitoring controller 507 determines whether or not a device mismatching error has occurred in the regular processing. The device mismatching error represents an error which occurs when device identification information acquired from a device, such as a serial number and a MAC address, differs from management information in the device management table.

When it is determined that a device mismatching error has occurred (Yes in S811), the monitoring controller 507 proceeds to S812. In S812, the monitoring controller 507 notifies the master monitoring apparatus 121 of a device mismatching error. At least a device ID for identifying the device in which the error has occurred is added to the notification data, as in S810. After the processing of S812, the monitoring controller 507 proceeds to S802.

Meanwhile, when it is determined that a device mismatching error has not occurred in the regular processing (No in S811) the monitoring controller 507 proceeds to S813.

In S813, the monitoring controller 507 determines whether or not a communication inability error has occurred in the regular processing. The communication inability error represents a communication error which occurs, for example, when a device access is rejected by a device main unit or a network relay device such as a router. Normally, communication timeout due to shutdown of the device is excluded from the communication inability error. Furthermore, the case where a timeout error continues for a long period of time (a threshold or more) may be treated as a communication inability error. In this case, although not illustrated in FIG. 14, an error continuation period may be determined by managing the error occurrence date and time, the last processing date and time, and the like as error information of the device.

When it is determined in S813 that a communication inability error has occurred in the regular processing (Yes in S813), the monitoring controller 507 proceeds to S814.

In S814, the monitoring controller 507 notifies the master monitoring apparatus 121 of a communication inability error. At least a device ID for identifying the device in which the error has occurred is added to the notification data, as in S810 and S812. After the processing of S814, the monitoring controller 507 proceeds to S802.

Meanwhile, when it is determined in S813 that a communication inability error has not occurred in the regular processing (No in S813), the monitoring controller 507 directly proceeds to S802.

When it is determined in S806 that the regular processing time has not been reached (No in S806), the monitoring controller 507 proceeds to S815.

In S815, the monitoring controller 507 determines whether or not a device monitoring stop request from the master monitoring apparatus 121 is detected (a device monitoring stop request from the master monitoring apparatus 121 is received).

When it is determined that a device monitoring stop request from the master monitoring apparatus 121 is detected (Yes in S815), the monitoring controller 507 proceeds to S816.

In S816, the monitoring controller 507 performs device monitoring stop processing. Specifically, the monitoring status of the device information in the device management table Td for the device specified by the device monitoring stop request is updated to monitoring stopped (STOPPED). By shifting the monitoring status to monitoring stopped (STOPPED), the monitoring controller 507 does not perform regular monitoring processing in S807 for the device. In the device monitoring stop processing of S816, the monitoring controller 507 further performs various types of processing for stop monitoring, such as instruction for canceling monitoring of the device. After the device monitoring stop processing in S816, the monitoring controller 507 proceeds to S802.

Meanwhile, when it is determined in S815 that the device monitoring stop request from the master monitoring apparatus 121 is not detected (No in S815), the monitoring controller 507 proceeds to S817.

In S817, the monitoring controller 507 determines whether or not a device deletion request from the master monitoring apparatus 121 is detected (a device deletion request from the master monitoring apparatus 121 is received).

When it is determined that a device deletion request from the master monitoring apparatus 121 is detected (Yes in S817), the monitoring controller 507 proceeds to S818.

In S818, the monitoring controller 507 performs device deletion processing. Specifically, processing for deleting registration of the device, such as instruction for deleting device information from the device management table Td and a monitoring list Ls (not illustrated in figures) and canceling monitoring of the device. After the device deletion processing in S818, the monitoring controller 507 proceeds to S802. In this embodiment, the slave monitoring apparatuses 101 and 111 each include the device management table Td and the monitoring list Ls, which is not illustrated in figures, and monitor devices registered with the monitoring list Ls. However, the slave monitoring apparatuses 101 and 111 may not hold the monitoring list Ls, and may monitor devices registered with the device management table Td.

Meanwhile, when it is determined in S817 that a device deletion request from the master monitoring apparatus 121 is not detected (No in S817), the monitoring controller 507 proceeds to S819.

In S819, the monitoring controller 507 determines whether or not a device communication test request from the master monitoring apparatus 121 is detected (a device communication test request from the master monitoring apparatus 121 is received).

When it is determined that a device communication test request from the master monitoring apparatus 121 is detected (Yes in S819), the monitoring controller 507 proceeds to S820.

In S820, the monitoring controller 507 performs device communication test processing. In S821, the monitoring controller 507 notifies the master monitoring apparatus 121 of a result of the communication test of S820. In the communication test, the monitoring controller 507 acquires device identification information such as a serial number and a MAC address from the target device via the device information acquisition unit 505. A determination as to which one of a serial number, a MAC address, and another type of information, is to be acquired, is made by a capability examination at the time of device registration. A serial number is acquired from a device from which the serial number may be acquired. In the case where the acquired device identification information is the same as a value of the device which is managed in the device management table, the result of the communication test is regarded as being successful, and the master monitoring apparatus 121 is notified of the success. In the case where the acquired device identification information is different from the value of the device, the result of the communication test is regarded as being error, and the master monitoring apparatus 121 is notified of a device mismatching error. Similarly, in the case where the device is not able to perform communication due to the shutdown or the like, a communication error is sent. After the processing of S821, the monitoring controller 507 proceeds to S802.

Meanwhile, when it is determined in S819 that a device communication test request from the master monitoring apparatus 121 is not detected (No in S819), the monitoring controller 507 proceeds to S822. In S822, the monitoring controller 507 determines whether or not a device information change request from the master monitoring apparatus 121 is detected (a device information change request from the master monitoring apparatus 121 is received).

When it is determined that a device information change request from the master monitoring apparatus 121 is detected (Yes in S822), the monitoring controller 507 proceeds to S823.

In S823, the monitoring controller 507 updates the contents of the device management table Td based on device information accompanied with the request, and proceeds to S802.

Meanwhile, when it is determined that a device information change request from the master monitoring apparatus 121 is not detected (No in S822), the monitoring controller 507 directly proceeds to S802.

Next, the device search processing in S803 will be described with reference to FIG. 9.

In the device search processing, in response to a request from the monitoring controller 507, the device searching unit 509 performs device search, and obtains a search result by performing comparison with a search target at the monitoring controller 507.

FIG. 9 is a flowchart illustrating the details of the device search processing of S803.

In S901, the monitoring controller 507 starts processing, using input arguments of the processing as a search method, a host name/IP address of a search device, a serial number of a search device, and a MAC address of a search device, and output arguments of the processing as a search result and a host name/IP address of a search device.

In S902, the monitoring controller 507 determines whether or not a search method of an input argument is an individual search instruction.

When it is determined that the search method of the input argument is an individual search instruction (Yes in S902) the monitoring controller 507 proceeds to S903.

In S903, by name resolution of the input argument, the monitoring controller 507 acquires the IP address for the case where the instruction is for a host name and the host name for the case where the instruction is for an IP address.

In S904, the monitoring controller 507 determines whether or not the name resolution is successful in S903. When it is determined that the name resolution is successful (Yes in S904), the monitoring controller 507 proceeds to S905.

In S905, the monitoring controller 507 requests the device searching unit 509 to search for a device which corresponds to the IP address acquired in S903 or the like, and acquires a serial number or a MAC address as device identification information of the device. For example, in the case where the host name of the search device is input as an input argument, the IP address is acquired based on the host name, and search for the device may be executed. That is, the monitoring controller 507 is able to perform the device search processing using (as an input) the host name of the search device.

In S906, the monitoring controller 507 determines whether or not the serial number or the MAC address acquired in S905 is the same as the serial number or MAC address of the search device as an input argument.

When it is determined that the acquired serial number or the MAC address is the same as the serial number or MAC address of the search device (Yes in S906), the monitoring controller 507 proceeds to S907.

In S907, the monitoring controller 507 notifies the master monitoring apparatus 121 of the success of the search, and ends the device search processing.

Meanwhile, when it is determined in S906 that the serial number or the MAC address acquired in S905 is not the same as the serial number or MAC address of the search device as an input argument (No in S906), the monitoring controller 507 proceeds to S908.

In S908, the monitoring controller 507 notifies the master monitoring apparatus 121 of the failure of the search (device mismatching error), and ends the device search processing.

When it is determined in S904 that the name resolution is unsuccessful (No in S904), the device searching unit 509 proceeds to S909.

In S909, the monitoring controller 507 notifies the master monitoring apparatus 121 of the failure of the search (name resolution error), and ends the device search processing.

When it is determined in S902 that the search method of the input argument is not an individual search instruction (No in S902), the monitoring controller 507 proceeds to S911.

In S911, the monitoring controller 507 determines whether or not the search method of the input argument is a full search instruction.

When it is determined that the search method of the input argument is a full search instruction (Yes in S911) the monitoring controller 507 proceeds to S912.

In S912, the monitoring controller 507 requests the device searching unit 509 to execute full search processing within a monitoring area by broadcasting or multicasting, in accordance with preset address specification within the monitoring area.

In S913, the monitoring controller 507 determines whether or not a device that is not registered with the monitoring list Ls, which is described above and not illustrated in figures, that is, a new device, is included in devices from which a response is acquired, as a result of the search in S912. When it is determined that a new device is present (Yes in S913), the monitoring controller 507 proceeds to S914.

In S914, the monitoring controller 507 requests the device searching unit 509 to acquire a serial number or a MAC address as device identification information of the device that corresponds to the IP address of the new device.

In S915, the monitoring controller 507 determines whether or not the serial number or the MAC address acquired in S914 is the same as the serial number or MAC address of the search device as the input argument.

When it is determined that the acquired serial number or the MAC address is the same as the serial number or MAC address of the search device (Yes in S915), the monitoring controller 507 proceeds to S916.

In S916, the monitoring controller 507 defines the IP address of the device that corresponds to the serial number/MAC address as an output argument “IP address of search device” or defines a host name as an output argument “host name of search device” if the host name may be resolved reversely, and then proceeds to S917.

In S917, the monitoring controller 507 notifies the master monitoring apparatus 121 of the success of the search, and ends the device search processing.

When it is determined in S915 that the serial number or the MAC address acquired in S914 is not the same as the serial number or MAC address of the search device as the input argument (No in S915), the monitoring controller 507 proceeds to S913.

When it is determined in S913 that a new device is not present (No in S913), the monitoring controller 507 proceeds to S918.

In S918, the monitoring controller 507 notifies the master monitoring apparatus 121 of the failure of the search (device mismatching error), and ends the device search processing.

When it is determined in S911 that the search method of the input argument is not a full search instruction (No in S911), the monitoring controller 507 proceeds to S919.

When an instruction for a different search method is issued, the monitoring controller 507 requests the device searching unit 509 to perform search in accordance with specification, and notifies the master monitoring apparatus 121 of a result of the search in S919. The details of S919 are not relevant to the essence of the present invention, and therefore explanation for S919 will be omitted. After the processing of S919, the monitoring controller 507 ends the device search processing.

Next, the device registration processing in S805 of FIG. 8A will be described with reference to FIG. 10.

FIG. 10 is a flowchart illustrating the details of the device registration processing according to the first embodiment. In the device registration processing, a device is registered when the management information acquisition unit 508 acquires information regarding a monitoring target device from the master monitoring apparatus 121 in response to a request from the monitoring controller 507 and the monitoring controller 507 determines whether or not registration is permitted. In the first embodiment, the determination as to whether or not registration is permitted is made by acquiring a missing device list from the master monitoring apparatus 121, as illustrated in FIG. 10.

Hereinafter, slave device monitoring registration processing of FIG. 10 will be described.

In S1001, the monitoring controller 507 starts the processing by using input arguments of the processing as a host name, an IP address, a serial number, and a MAC address of a monitoring target device A, and using an output argument as a host name. It is assumed that either a host name or an IP address or both the host name and the IP address are specified as an input argument.

Next, in S1002, the monitoring controller 507 determines whether either a host name H or an IP address X is unspecified as an input argument. When it is determined that either the host name H or the IP address X is unspecified as an input argument (Yes in S1002), the monitoring controller 507 proceeds to S1003.

In S1003, the monitoring controller 507 acquires, by name resolution, the IP address X from the host name H or the host name H from the IP address X, and proceeds to S1004.

Meanwhile, when it is determined both of the host name H and the IP address X are specified as input arguments (NO in S1002), the monitoring controller 507 (No in S1002), the monitoring controller 507 directly proceeds to S1004.

In S1004, the monitoring controller 507 requests the management information acquisition unit 508 to acquire a missing device list from the master monitoring apparatus 121. In response to the request, the management information acquisition unit 508 acquires the missing device list from the master monitoring apparatus 121. The missing device list is a list which covers, among all the devices to be monitored by all the slave monitoring apparatuses which are monitored by the master monitoring apparatus 121, devices whose monitoring status is ready-for-monitoring (READY), monitoring stopped (STOPPED), and communication inability error (ERROR). The above devices are devices “that are to be monitored but are not being monitored”. Therefore, if a registration target device is determined to be included in the missing device list, registration of the registration target device becomes possible.

After the processing of S1004, the monitoring controller 507 determines whether or not it is confirmed that the registration target device (device A) is included in the missing device list, by using a serial number Y and a MAC address Z, which are device identification information, among input arguments, as a key in S1005.

When it is determined that it is confirmed that the device A is included in the missing device list (Yes in S1005), the monitoring controller 507 proceeds to S1006.

In S1006, the monitoring controller 507 registers the device A with the device management table Td and the monitoring list Ls. For the device A, the registration status is set to registration-in-progress (REGISTERING) and the monitoring status is set to ready-for-monitoring (READY). Next, in S1007, the monitoring controller 507 starts monitoring of the device A.

In S1006 and S1007, an example in which registration and monitoring of a device is started autonomously and immediately without obtaining a permission from the master monitoring apparatus 121 and the central management apparatus 131 is described. With this configuration, an effect of shortening the monitoring stop time may be achieved. In the case where the monitoring start processing is finished normally, the monitoring controller 507 shifts the registration status to registration completed (REGISTERED) and the monitoring status to monitoring-in-progress (WATCHING). When an error occurs during the monitoring start processing, the monitoring status is shifted to error (ERROR), and an error cause is changed appropriately, and a retry is made. The retry is different from the essence of the present invention, and therefore explanation for the retry will be omitted.

After the processing of S1007 (that is, after the monitoring processing is started), the monitoring controller 507 notifies the master monitoring apparatus 121 of the start of device monitoring for the device A. The device monitoring start notification, which includes at least, as device information, device identification information such as a serial number/MAC address and communication information such as an IP address/host name, is transmitted. After the processing of S1008, the monitoring controller 507 ends the slave device monitoring registration processing.

When it is determined in S1005 that it is not confirmed that the device A is included in the missing device list, by using the serial number Y and the MAC address, which are device identification information, among input arguments, as a key (No in S1005) the monitoring controller 507 ends the device monitoring registration processing.

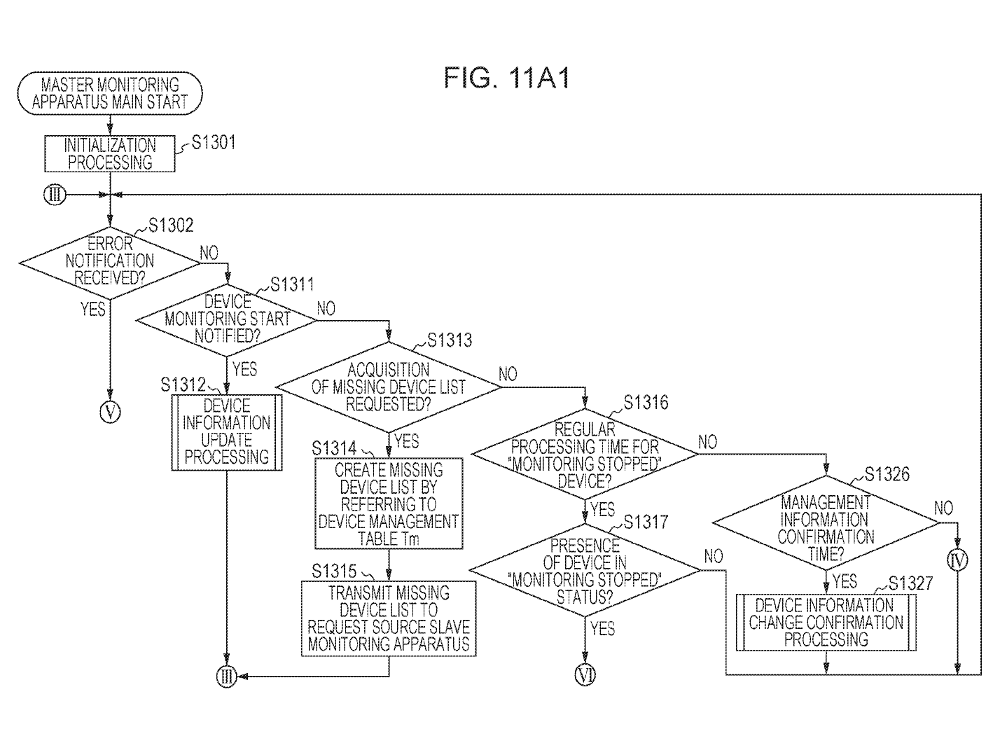

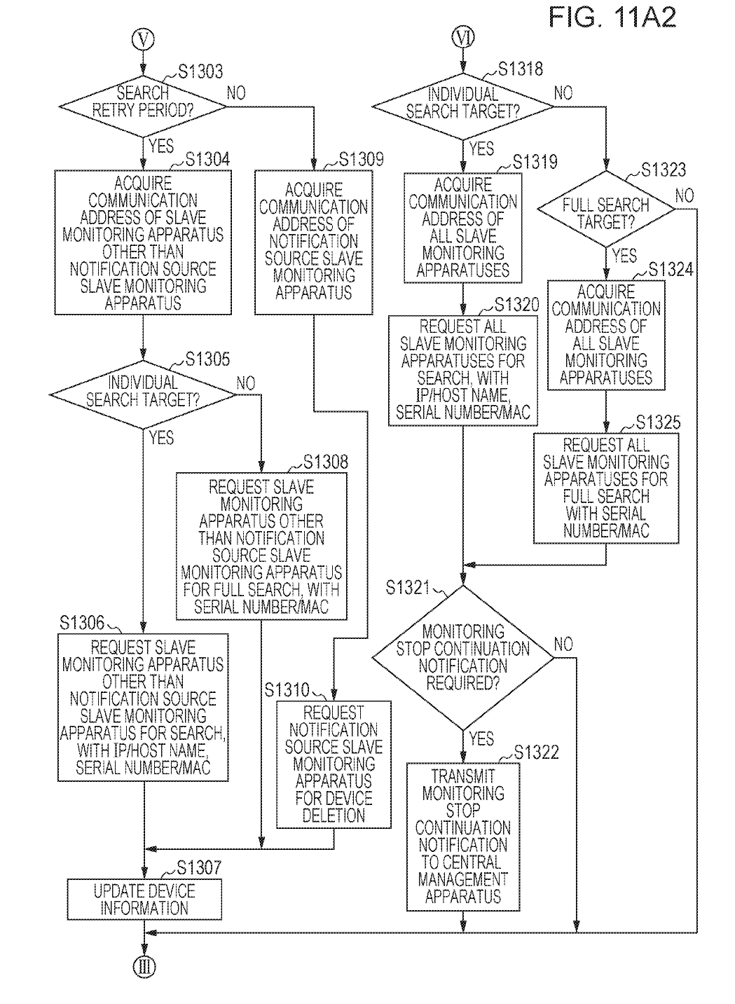

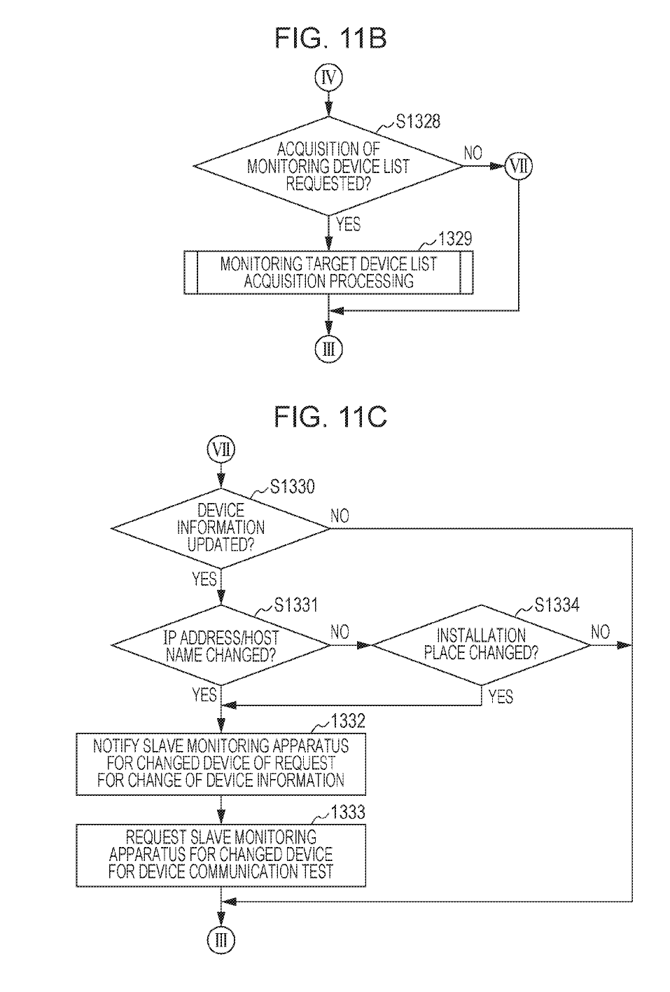

FIGS. 11A1 and 11A2 are main flowcharts illustrating an operation of the master monitoring apparatus 121. Processing of individual steps illustrated in flowcharts of FIGS. 11A1, 11A2, 12A, 12B, and 13A, 13B are implemented when the CPU 201 provided in the master monitoring apparatus 121 reads and executes a control program according to an embodiment of the present invention stored in a nonvolatile storage device such as the ROM 202 or the HD 205. Furthermore, in the flowcharts, only processing relevant to the present invention will be explained. Since processing not relevant to the present invention is different from the essence of the present invention, explanation for that processing will be omitted. In addition, unless otherwise stated, the processing is mainly operated by the monitoring controller 405 in cooperation with each unit as necessary. FIG. 11B will be described in the second embodiment, and FIG. 11C will be described in a third embodiment.

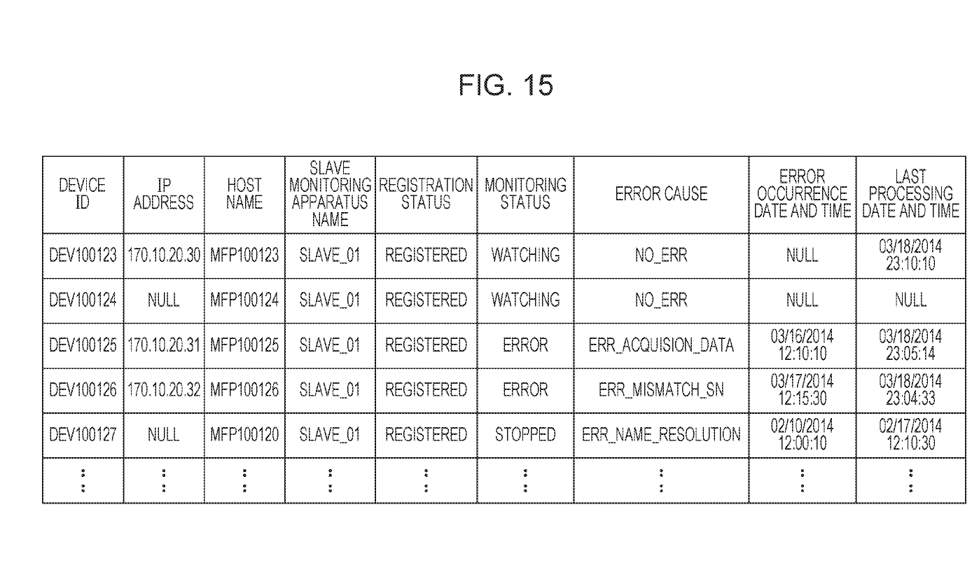

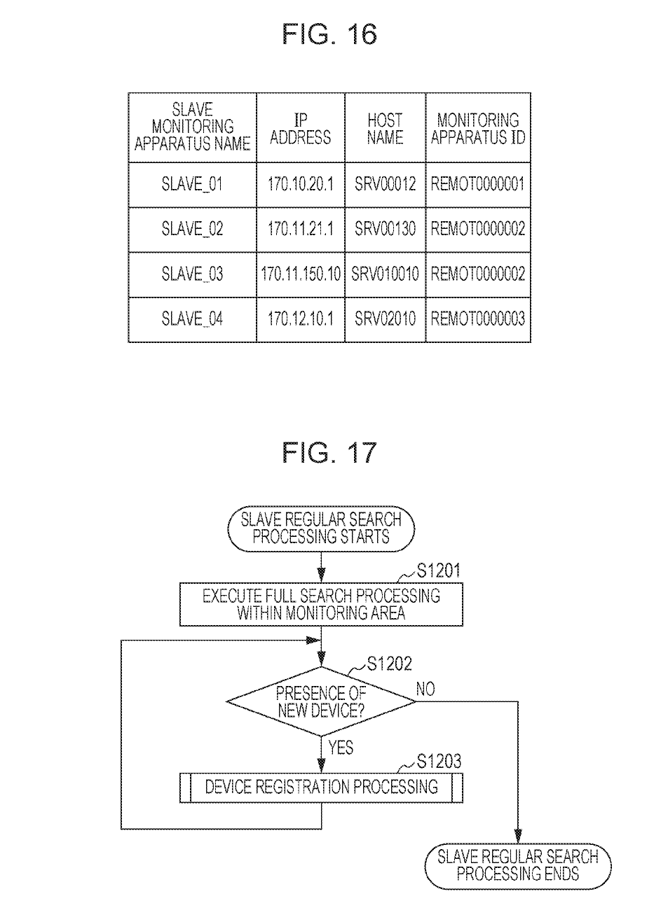

When the power is applied to the master monitoring apparatus 121, the master monitoring apparatus 121 first initializes the system in accordance with the application of the power (S1301). Specifically, the master monitoring apparatus 121 performs reading of initialization setting information, initialization processing of each operation unit, and the like. For example, the device information management unit 406 accesses a slave monitoring apparatus management table Ts (FIG. 16), a device management table Tm (FIG. 15), and the like from the database 124 via the database access unit 404, and reads information for initialization onto a working memory such as the RAM 203. The details of the slave monitoring apparatus management table Ts (FIG. 16) and the device management table Tm (FIG. 15) will be described later along with the explanation of the flowcharts.

Next, in S1302, the monitoring controller 405 determines whether or not an error notification from the slave monitoring apparatuses 101 and 111 is detected (an error notification from the slave monitoring apparatuses 101 and 111 is received). Furthermore, in this embodiment, the case where an error is notified from a device when a communication test is requested to the slave monitoring apparatus is also processed in step S1302.

When it is determined that an error notification from the slave monitoring apparatuses 101 and 111 is detected (Yes in S1302), the monitoring controller 405 proceeds to S1303.

In S1303, the monitoring controller 405 determines whether or not the current time is within a search retry period. The determination is made by acquiring device information of a device that corresponds to the error notification from the device management table Tm (FIG. 15) stored in the database 124.

The device management table Tm will be explained with reference to FIG. 15.

FIG. 15 is a diagram illustrating the device management table Tm. The device management table Tm is stored and managed in the database 124.

As illustrated in FIG. 15, the device management table Tm according to this embodiment holds a device ID, an IP address, a host name, a slave monitoring apparatus name, a registration status, a monitoring status, an error cause, an error occurrence date and time, a last processing date and time, and the like as items. Furthermore, device information other than the above items is also included in the device management table Tm in the database 124. However, such device information is not relevant to the essence of the present invention, and therefore explanation for such device information will be omitted. Furthermore, the device ID, the ID address, the host name, the registration status, the monitoring status, and the error cause are similar to those in FIG. 14, and therefore explanation for those similar items will be omitted. Only different items will be explained.

Referring to FIG. 15, the slave monitoring apparatus name is a name which uniquely identifies a slave monitoring apparatus. In this embodiment, the slave monitoring apparatus name is defined as a name which uniquely identifies a slave monitoring apparatus. However, the slave monitoring apparatus name may be an ID which uniquely identifies a slave monitoring apparatus.

The error occurrence date and time is information which indicates a point in time when the monitoring status is updated to “ERROR”. If the error status continues with the same error cause, the item of the last processing date and time is updated. Based on the error occurrence date and time and the last processing date and time, the error continuation period may be calculated. Therefore, permission or inhibition of retry of search may be determined based on the error continuation period. In this embodiment, the monitoring controller 405 determines whether or not the current time is within the search retry period (that is, permission or inhibition of retry of search) in S1303 of FIG. 11A2 by comparing the calculated error continuation period with a preset search retry period. For example, in the case where the error continuation period does not exceed the search retry period, the monitoring controller 405 determines that the current time is within the search retry period. When the error continuation period exceeds the search retry period, the monitoring controller 405 determines that the current time is not within the search retry period.

When it is determined in S1303 that the current time is within the search retry period (Yes in S1303), the monitoring controller 405 proceeds to S1304.

In S1304, the monitoring controller 405 acquires a communication address of a slave monitoring apparatus different from the notification source slave monitoring apparatus. For this acquisition, the slave monitoring apparatus management table Is is used.

The slave monitoring apparatus management table Ts will be explained with reference to FIG. 16.

FIG. 16 is a diagram illustrating the slave monitoring apparatus management table Ts. The slave monitoring apparatus management table Ts is stored and managed in the database 124.

As illustrated in FIG. 16, the slave monitoring apparatus management table Ts in this embodiment holds a slave monitoring apparatus name, an IP address, a host name, a monitoring apparatus ID, and the like as items. Furthermore, management information other than the above items is also included in the slave monitoring apparatus management table Ts in the database 124. However, such management information is not relevant to the essence of the present invention, and therefore explanation for such management information will be omitted.

Referring to FIG. 16, the slave monitoring apparatus name is a name which uniquely identifies a slave monitoring apparatus, as described above. The IP address and the host name are used as a communication address of each slave monitoring apparatus, and only one of the IP address and the host name may be used. The monitoring apparatus ID is a monitoring apparatus ID which is managed by the central management apparatus 131. Normally, a single monitoring apparatus ID is allocated to each slave monitoring apparatus. For example, in the case where a plurality of slave monitoring apparatuses are arranged in a single site in a large-scale environment, the same monitoring apparatus is allocated to a plurality of slave monitoring apparatuses.

In S1304 of FIG. 11A2, the monitoring controller 405 excludes the slave monitoring apparatus of the above error notification source from among all the slave monitoring apparatuses that the master monitoring apparatus 121 manages, and acquires an IP address from the slave monitoring apparatus management table Ts.

In S1305, the monitoring controller 405 determines whether or not a search device (device corresponding to the error notification) is an individual search target. For example, conditions that the error continuation period for a search device in the device management table Tm whose error cause is a name resolution error (ERR NAME RESOLUTION) is less than or equal to a threshold, are set in advance. When the conditions are met, it is determined that the search device is an individual search target. The conditions may be variable by an external file or the like.

When it is determined in S1305 that the search device is an individual search target (Yes in S1305), the monitoring controller 405 proceeds to S1306.

In S1306, the monitoring controller 405 transmits a search request, with the host name/IP address being specified, to the slave monitoring apparatus different from the notification source slave monitoring apparatus. At least a host name/IP address and a serial number/MAC address of the search device are added to the request. After the processing of S1306, the monitoring controller 405 proceeds to S1307.

Meanwhile, when it is determined in S1305 that the search device is not an individual search target (No in S1305), the monitoring controller 405 proceeds to S1308.

In S1308, the monitoring controller 405 transmits a full search request to the slave monitoring apparatus that is different from the notification source slave monitoring apparatus. At least a serial number/MAC address of the search device is added to the request. After the processing of S1308, the monitoring controller 405 proceeds to S1307.

When it is determined in S1303 that the current time is not within the search retry period (No in S1303), the monitoring controller 405 proceeds to S1309.

In S1309, the monitoring controller 405 acquires the communication address of the notification source slave monitoring apparatus from the slave monitoring apparatus management table Ts. In S1310, the monitoring controller 405 requests the notification source slave monitoring apparatus for device deletion. That is, in the case where an error of at least one of a failure in name resolution, mismatching of registered address information, and a failure in a communication test continues for a time exceeding a predetermined time (search retry period), the monitoring controller 405 determines that monitoring is impossible, and the monitoring controller 405 transmits a request to the error notification source slave monitoring apparatus for deletion of the device that corresponds to the error notification from a monitoring target. After the processing of S1310, the monitoring controller 405 proceeds to S1307.

After the processing of S1306, S1308, or S1310, the monitoring controller 405 updates device information in the device management table Tm, based on the notified error information in S1307. Specifically, the monitoring status, the error cause, the error occurrence date and time, and the last processing date and time are updated. After the processing of S1307, the monitoring controller 405 proceeds to S1302.

When it is determined in S1302 that an error notification from the slave monitoring apparatus is not detected (No in S1302), the monitoring controller 405 proceeds to S1311.

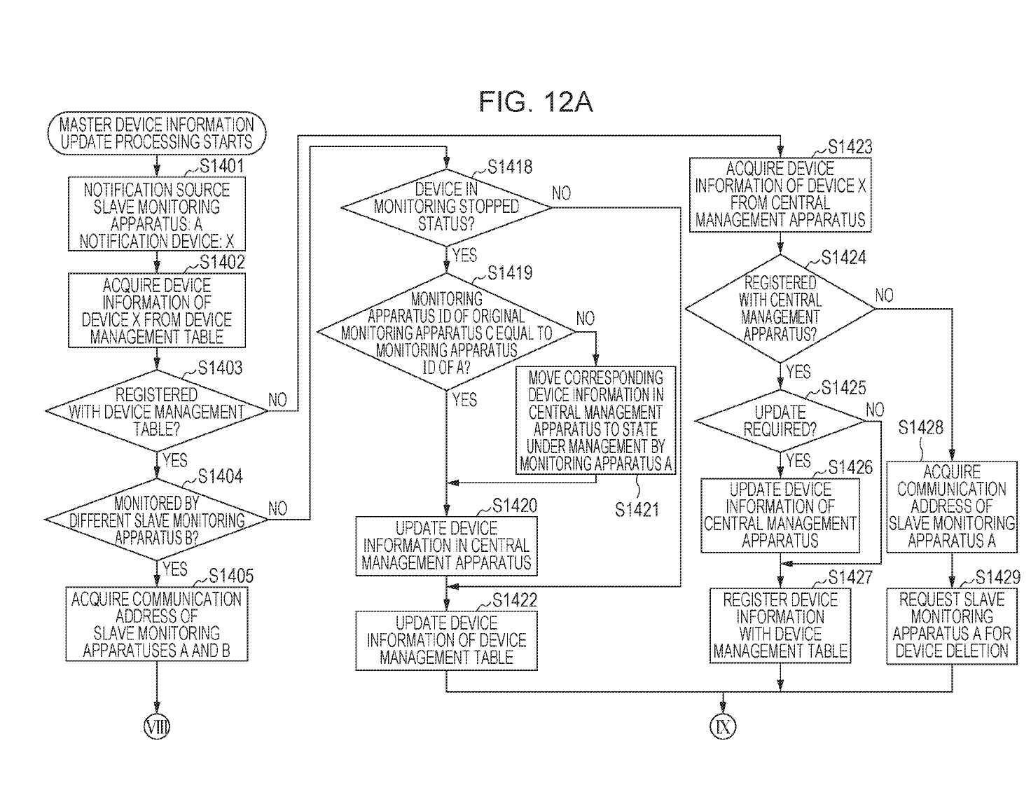

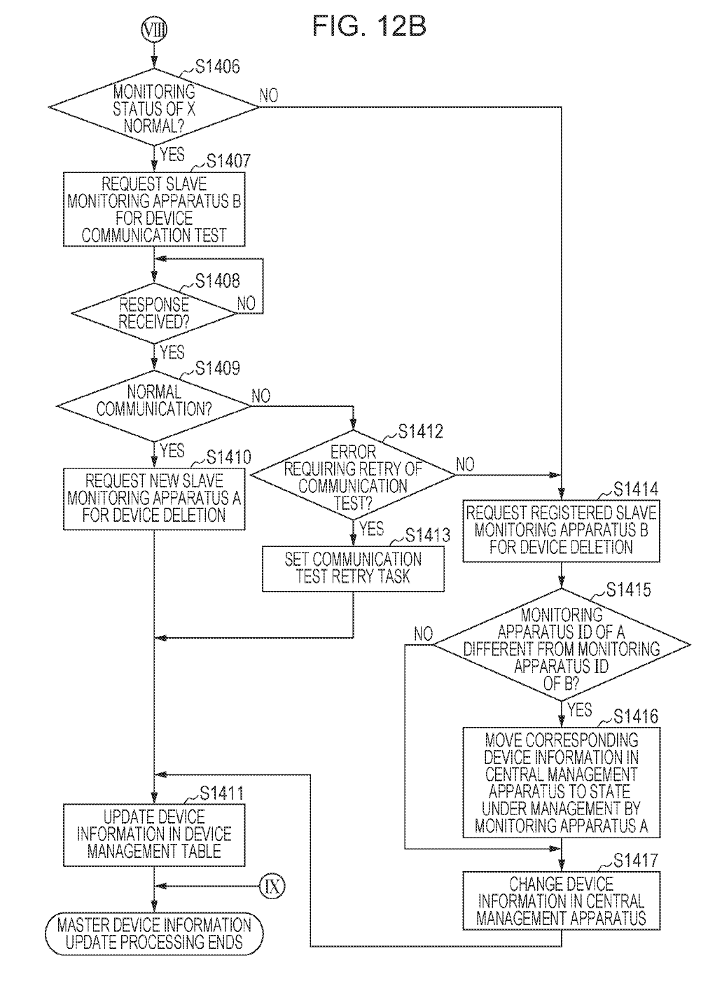

In S1311, the monitoring controller 405 determines whether or not a device monitoring start notification from the slave monitoring apparatus is detected (a device monitoring start notification from the slave monitoring apparatus is received). When it is determined that a device monitoring start notification from the slave monitoring apparatus is detected (Yes in S1311), the monitoring controller 405 executes device information update processing for the device that corresponds to the device monitoring start notification in S1312. The device information update processing will be described later with reference to FIGS. 12A and 12B. After the processing of S1312, the monitoring controller 405 proceeds to S1302.

Meanwhile, when it is determined that a device monitoring start notification from the slave monitoring apparatus is not detected (No in S1311), the monitoring controller 405 proceeds to S1313.

In S1313, the monitoring controller 405 determines whether or not a request for acquisition of a missing device list from the slave monitoring apparatus is detected (a request for acquisition of a missing device list from the slave monitoring apparatus is received). When it is determined that a request for acquisition of a missing device list from the slave monitoring apparatus is detected (Yes in S1313), the monitoring controller 405 proceeds to S1314.

In S1314, the monitoring controller 405 refers to the device management table Tm to create a missing device list. The missing device list is a list which convers devices whose monitoring status is ready-for-monitoring (READY), monitoring stopped (STOPPED), and communication inability error (ERROR) in the device management table Tm.

Next, in S1315, the monitoring controller 405 transmits the missing device list created in S1314 to the request source slave monitoring apparatus, and proceeds to S1302.

When it is determined in S1313 that a request for acquisition of the missing device list from the slave monitoring apparatus is not detected (No in S1313), the monitoring controller 405 proceeds to S1316.

In S1316, the monitoring controller 405 determines whether or not the regular processing time for the “monitoring stopped” device has been reached. When it is determined that the regular processing time for the “monitoring stopped” device has been reached (Yes in S1316), the monitoring controller 405 proceeds to S1317.

In S1317, the monitoring controller 405 refers to the device management table Tm, and determines whether or not a device whose monitoring status is “monitoring stopped” is present. When it is determined that a device whose monitoring status is “monitoring stopped” is not present (No in S1317), the monitoring controller 405 directly proceeds to S1302.

Meanwhile, when it is determined that a device whose monitoring status is “monitoring stopped” is present (Yes in S1317), the monitoring controller 405 proceeds to S1318.

In S1318, the monitoring controller 405 determines whether or not the search device (device whose monitoring status is “monitoring stopped”) is an individual search target. The determination conditions are described in the explanation for S1305. When it is determined that the search device is an individual search target (Yes in S1318), the monitoring controller 405 proceeds to S1319.

In S1319, the monitoring controller 405 refers to the slave monitoring apparatus management table Ts, and acquires the communication address of all the slave monitoring apparatuses. In S1320, the monitoring controller 405 transmits a search request, with the IP address/host name being specified, to all the slave monitoring apparatuses. At least the IP address/host name and the serial number/MAC address of the search device are added to the request. After the processing of S1319, the monitoring controller 405 proceeds to S1321.

When it is determined in S1318 that the search device is not an individual search target (No in S1318), the monitoring controller 405 proceeds to S1323.

In S1323, the monitoring controller 405 determines whether or not the search device is a full search target within a monitoring area. The determination conditions are that individual search is not possible, individual search cannot be performed for a certain period of time or more, and the current time is within a search retry period. The above conditions may also be variable by an external file, as described above.

When it is determined in S1323 that the search device is not a full search target within the monitoring area (No in S1323), the monitoring controller 405 directly proceeds to S1302.

Meanwhile, when it is determined in S1323 that the search device is a full search target within the monitoring area (Yes in S1323), the monitoring controller 405 proceeds to S1324.

In S1324, the monitoring controller 405 acquires the communication address of all the slave monitoring apparatuses that the master monitoring apparatus 121 monitors from the slave monitoring apparatus management table Ts. In S1325, the monitoring controller 405 transmits a search request, with device full search being specified, to all the slave monitoring apparatuses. At least the serial number/MAC address of the search device is added to the request. After the processing of S1325, the monitoring controller 405 proceeds to S1321.

After the processing of S1320 and S1325, the monitoring controller 405 determines in S1321 whether or not a monitoring stop continuation notification is to be sent to the central management apparatus 131. The monitoring stop continuation notification is a notification to be sent to the central management apparatus 131, of continuation of monitoring stop, that is, abnormality of a device for which management is performed by the central management apparatus 131 but monitoring is stopped. In this embodiment, registration is deleted on the slave monitoring apparatus side in S1310. Therefore, an error notification regarding monitoring stop to the central management apparatus is performed by the master monitoring apparatus 121 instead. If “monitoring stopped” is instructed without deleting registration on the slave monitoring apparatus side, the slave monitoring apparatus may transmit the error notification to the central management apparatus 131.

When it is determined in S1321 that the monitoring stop continuation notification is required (Yes in S1321), the monitoring controller 405 transmits the monitoring stop continuation notification to the central management apparatus 131 in S1322, and proceeds to S1302.

Meanwhile, when it is determined in S1321 that the monitoring stop continuation notification is not required (No in S1321), the monitoring controller 405 directly proceeds to S1302.

When it is determined in S1316 that the current time is not within the regular processing time for the “monitoring stopped” device (No in S1316), the monitoring controller 405 proceeds to S1326.

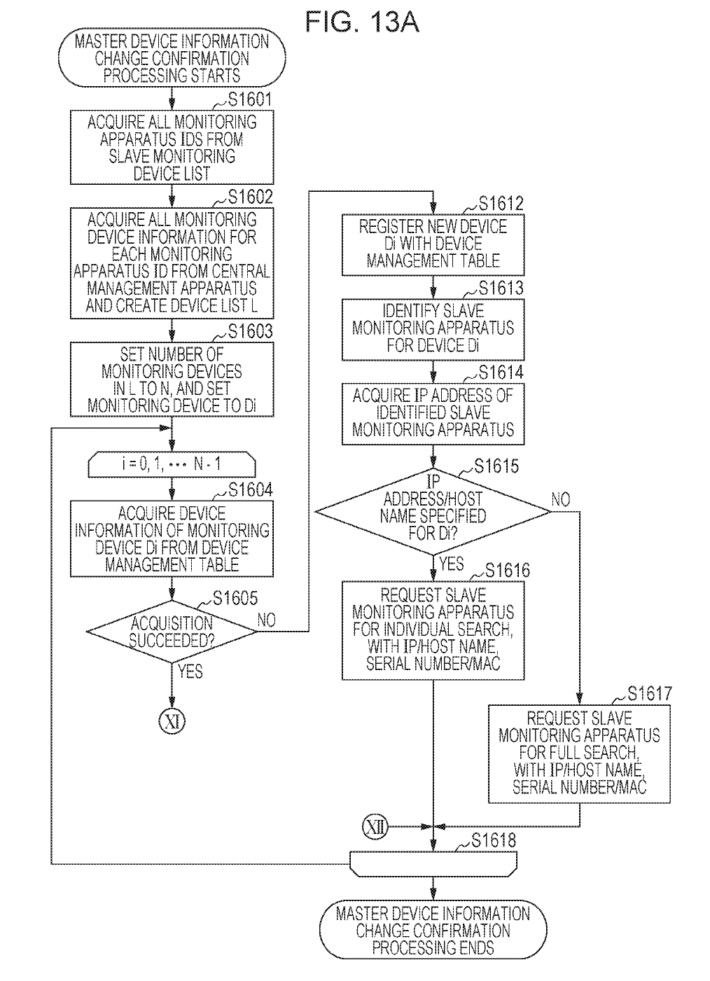

In S1326, the monitoring controller 405 determines whether or not, as regular processing, the current time is within a management information confirmation time. When it is determined that the current time is within the management information confirmation time (Yes in S1326), the monitoring controller 405 executes device information change confirmation processing in S1327. The device information change confirmation processing will be described later with reference to FIGS. 13A and 13B. After the processing of S1327, the monitoring controller 405 proceeds to S1302.

Meanwhile, when it is determined that the current time is not within the management information confirmation time (No in S1326), the monitoring controller 405 directly proceeds to S1302 in the first embodiment.

In S1310, the notification source slave monitoring apparatus is requested for device deletion. When device information is updated in S1307, the monitoring controller 405 may proceed to S1317 without waiting for the regular processing time for the “monitoring stopped” device so that search may be request to another slave monitoring apparatus.

Next, the device information update processing of S1312 in FIG. 11A1 will be described with reference to FIGS. 12A and 12B. FIGS. 12A and 12B are flowcharts illustrating the device information update processing of S1312 in FIG. 11A1.

In S1401, the monitoring controller 405 starts processing by setting a notification source slave monitoring apparatus of a device monitoring start notification as A and setting a device for which monitoring is started to X.

In S1402, the monitoring controller 405 acquires device information of the device X from the device management table Tm.

Next, in S1403, the monitoring controller 405 determines whether or not the device information of the device X is acquired in S1402, that is, whether or not the device information of the device X is registered with the device management table Tm. When it is determined that the device information of the device X is registered with the device management table Tm (Yes in S1403), the monitoring controller 405 proceeds to S1404.

In S1404, the monitoring controller 405 determines whether or not a different slave monitoring apparatus B is monitoring the device X. Specifically, in the case where the value of the slave monitoring apparatus name within the acquired device information is different from the device name of the slave monitoring apparatus A and the monitoring status is “WATCHING”, based on the slave monitoring apparatus management table Ts, it is determined that the different slave monitoring apparatus B is monitoring the device X.

When it is determined that the different slave monitoring apparatus B is monitoring the device X (Yes in S1404), the monitoring controller 405 proceeds to S1405.

In S1405, the monitoring controller 405 refers to the slave monitoring apparatus management table Ts to acquire a communication destination address of the slave monitoring apparatuses A and B.

Next, in S1406, the monitoring controller 405 determines whether or not the monitoring status of the device X is normal. When it is determined that the monitoring status of the device X is normal (Yes in S1406), the monitoring controller 405 proceeds to S1407.

In S1407, the monitoring controller 405 requests the slave monitoring apparatus B for a device communication test.

Next, in S1408, the monitoring controller 405 determines whether or not a response to the request in S1407, that is, a result response to the communication test, is received. When it is determined that the result response to the communication test is not received (No in S1408), the monitoring controller 405 waits until a response is received. When it is determined that the result response to the communication test is received (Yes in S1408), the monitoring controller 405 proceeds to S1409.

In S1409, the monitoring controller 405 determines whether or not the result of the communication test is normal. When it is determined that the result of the communication test is normal (Yes in S1409), the monitoring controller 405 requests the slave monitoring apparatus A from which registration is newly notified for device deletion in S1410. In the processing of S1410, an example in which when a device may be monitored by a plurality of slave monitoring apparatuses, priority is given to the slave monitoring apparatus which has already started to monitor the device, and an instruction for device registration cancelation and monitoring stop is issued to the slave monitoring apparatus which newly starts monitoring, is explained. With this configuration, an effect of suppressing an unnecessary change of the slave monitoring apparatus can be achieved. After the processing of S1410, the monitoring controller 405 proceeds to S1411.

Meanwhile, when it is determined in S1409 that a result of the communication test is not normal (No in S1409), the monitoring controller 405 proceeds to S1412.

In S1412, the monitoring controller 405 determines whether or not the result of the communication test is an error which requires a retry. For example, a communication timeout error which indicates device shutdown corresponds to an error which requires a retry.

When it is determined that the result of the communication test is an error which requires a retry (Yes in S1412), the monitoring controller 405 proceeds to S1413.

In S1413, the monitoring controller 405 sets a communication test retry task. A flow in which the communication test retry task is executed is not relevant to the essence of the present invention, and therefore explanation for the flow will be omitted. After the processing of S1413, the monitoring controller 405 proceeds to S1411.

Meanwhile, when it is determined in S1412 that the result of the communication test is not an error which requires a retry (No in S1412), the monitoring controller 405 proceeds to S1414.

When it is determined in S1406 that the monitoring status of the device X is not normal (No in S1406), the monitoring controller 405 proceeds to S1414.

In S1414, the monitoring controller 405 transmits a device deletion request to the slave monitoring apparatus B, which is registered with the device management table Tm. In S1414, an example in which in the case where a slave monitoring apparatus which has already started to monitor a device is present or the corresponding slave monitoring apparatus cannot monitor a device, an instruction for device registration cancelation and monitoring stop is issued to the slave monitoring apparatus which has already started to monitor the device, is explained. With this configuration, an effect of reducing an unnecessary processing load of the slave monitoring apparatus which has already started monitoring may be achieved.

After the processing of S1414, the monitoring controller 405 determines in S1415, by referring to the slave monitoring apparatus management table Ts, whether or not the monitoring apparatus ID of the slave monitoring apparatus A is different from the monitoring apparatus ID of the slave monitoring apparatus B. When it is determined that the monitoring apparatus ID of the slave monitoring apparatus A is different from the monitoring apparatus ID of the slave monitoring apparatus B (Yes in S1415), the monitoring controller 405 proceeds to S1416.

In S1416, the monitoring controller 405 instructs the central management apparatus 131 to move the device information of the device X from the state under the management by the slave monitoring apparatus B to the state under the management by the slave monitoring apparatus A. That is, the monitoring controller 405 instructs the central management apparatus 131 to associate the device information of the device X which is associated with the slave monitoring apparatus B with the slave monitoring apparatus A. After the processing of S1416, the monitoring controller 405 proceeds to S1417.

Meanwhile, when it is determined in S1415 that the monitoring apparatus ID of the slave monitoring apparatus A is equal to the monitoring apparatus ID of the slave monitoring apparatus B (No in S1415), the monitoring controller 405 proceeds to S1417.

In S1417, the monitoring controller 405 controls registration information within the central management apparatus 131 to be updated based on the device information (the IP address, the host name, the serial number, the MAC address, and the like) notified in the device monitoring start notification, and proceeds to S1411.

After the processing in S1410, S1413, or S1417, the monitoring controller 405 updates the device information of the device X in the device management table Tm within the master monitoring apparatus 121, based on the device information notified in the device monitoring start notification or the like in S1411. In the case where the slave monitoring apparatus or the monitoring status is changed, the slave monitoring apparatus name or the monitoring status is also updated. After the processing of S1411, the monitoring controller 405 ends the device information update processing.

When it is determined in S1404 that the different slave monitoring apparatus B is not monitoring the device X (No in S1404), the monitoring controller 405 proceeds to S1418.

In S1418, the monitoring controller 405 determines whether or not the device X is in the monitoring stopped (STOPPED) status. When it is determined that the device X is in the monitoring stopped status (Yes in S1418), the monitoring controller 405 proceeds to S1419.

In S1419, the monitoring controller 405 determines, by referring to the slave monitoring apparatus management table Ts, whether or not the monitoring apparatus ID of the slave monitoring apparatus A is the same as the monitoring apparatus ID of the original slave monitoring apparatus C. The original slave monitoring apparatus C is identified by referring to the device management table Tm.

When it is determined that the monitoring apparatus ID of the slave monitoring apparatus A is the same as the monitoring apparatus ID of the original slave monitoring apparatus C (Yes in S1419), the monitoring controller 405 proceeds to S1420.

Meanwhile, when it is determined in S1419 that the monitoring apparatus ID of the slave monitoring apparatus A is not the same as the monitoring apparatus ID of the original slave monitoring apparatus C (No in S1419), the monitoring controller 405 proceeds to S1421.

In S1421, the monitoring controller 405 instructs the central management apparatus 131 to move the device information of the device X from the state under the management by the slave monitoring apparatus C to the state under the management by the slave monitoring apparatus A. That is, the monitoring controller 405 instructs the central management apparatus 131 to associate the device information of the device X which is associated with the slave monitoring apparatus C with the slave monitoring apparatus A. After the processing of S1421, the monitoring controller 405 proceeds to S1420.

After the processing of S1421 or when the determination result in S1419 is Yes, the monitoring controller 405 updates the registration information within the central management apparatus 131 based on the device information notified in the device monitoring start notification in S1420, as in S1417, and proceeds to S1422.

When it is determined in S1418 that the device X is not in the monitoring stopped status (No in S1418), the monitoring controller 405 directly proceeds to S1422.

After the processing of S1420 or the determination result in S1418 is No, the monitoring controller 405 updates the device information in the device management table Tm within the master monitoring apparatus 121, based on the device information notified in the device monitoring start notification in S1422, as in S1411, and ends the processing of the flowchart.

When it is determined in S1403 that the device information of the device X is not registered with the device management table Tm (No in S1403), the monitoring controller 405 proceeds to S1423.

In S1423, the monitoring controller 405 acquires device information of the device X from the central management apparatus 131. Next, in S1424, the monitoring controller 405 determines whether or not the device information of the device X is acquired from the central management apparatus 131 in S1423, that is, whether or not the device X is registered with the central management apparatus 131. When it is determined that the device X is registered with the central management apparatus 131 (Yes in S1424), the monitoring controller 405 proceeds to S1425.

In S1425, the monitoring controller 405 determines, by comparing the device information notified in the device monitoring start notification with the device information acquired in S1423, whether or not to update information registered in the central management apparatus 131.

When it is determined that the information registered in the central management apparatus 131 is to be updated (Yes in S1425), the monitoring controller 405 updates the registration information in the central management apparatus 131, based on the device information notified in the device monitoring start notification in S1426, and proceeds to S1427.

Meanwhile, when it is determined that the information registered in the central management apparatus 131 is not to be updated (No in S1425), the monitoring controller 405 directly proceeds to S1427.

After the processing of S1426 or the determination result in S1425 is No, the monitoring controller 405 registers the device information of the device X with the device management table Tm, based on the device information notified in the device monitoring start notification in S1427, and ends the device information update processing.

When it is determined in S1424 that the device X is not registered with the central management apparatus 131 (No in S1424), the monitoring controller 405 proceeds to S1428.

In S1428, the monitoring controller 405 acquires a communication address of the slave monitoring apparatus A. In S1429, the monitoring controller 405 requests the slave monitoring apparatus A for device deletion. After the processing of S1429, the monitoring controller 405 ends the device information update processing.

Next, the device information change confirmation processing in S1327 of FIG. 11A1 will be described with reference to FIGS. 13A and 13B.

FIGS. 13A and 13B are flowcharts illustrating the device information change confirmation processing in S1327 of FIG. 11A1. This processing is processing for confirming whether the registration information in the central management apparatus 131 is not changed from the management information in the master monitoring apparatus 121.

First, in S1601, the monitoring controller 405 acquires the monitoring apparatus ID of all the slave monitoring apparatuses from the slave monitoring apparatus management table Ts.

Next, in S1602, the monitoring controller 405 acquires all device information for each monitoring apparatus ID acquired in S1601 from the central management apparatus 131 (acquires all device information associated with a monitoring apparatus ID for each monitoring apparatus ID), and creates a device list L which includes the acquired all device information. It is assumed that the device information of the device list L includes information such as a monitoring apparatus ID and an installation place of a slave monitoring apparatus that manages a device.

Next, in S1603, for confirmation of a change in each device in the list L, the monitoring controller 405 performs control such that processing of S1604 to S1618 is executed for monitoring devices Di (i=0, . . . , and N−1, where the number of monitoring devices in the device list L is represented by N and the ith monitoring device in the device list L is represented by Di (i=0, . . . , and N−1).

In S1604, the monitoring controller 405 acquires device information from the device management table Tm, by using the device ID of the monitoring device Di as a key.

Next, in S1605, the monitoring controller 405 determines whether or not the device information is acquired from the device management table Tm by using the device ID of the monitoring device Di acquired in S1604 as a key, that is, whether or not the device information corresponding to the device ID of the monitoring device Di is registered with the device management table Tm.

When it is determined that the device information corresponding to the device ID of the monitoring device Di is registered with the device management table Tm (Yes in S1605), the monitoring controller 405 proceeds to S1606.

In S1606, the monitoring controller 405 compares the device information of the monitoring device Di registered with the device management table Tm with the device information of the monitoring device Di acquired from the central management apparatus 131.

Furthermore, in S1607, the monitoring controller 405 determines whether or not the monitoring apparatus ID of the slave monitoring apparatus that monitors the monitoring device Di is different between the device information of the monitoring device Di registered with the device management table Tm and the device information acquired from the central management apparatus 131.

When it is determined that the monitoring apparatus ID is different (Yes in S1607), the monitoring controller 405 proceeds to S1608.

Meanwhile, when it is determined that the monitoring apparatus ID is the same (No in S1607), the monitoring controller 405 proceeds to S1610.

In S1610, the monitoring controller 405 determines whether or not the communication information such as the IP address/host name is different between the device information of the monitoring device Di registered with the device management table Tm and the device information acquired from the central management apparatus 131. When it is determined that the communication information such as the IP address/host name is different (Yes in S1610), the monitoring controller 405 proceeds to S1608.

Meanwhile, when it is determined that the communication information such as the IP address/host name is the same (No in S1610), the monitoring controller 405 proceeds to S1611.

In S1611, the monitoring controller 405 determines whether or not the installation place is different between the device information of the monitoring device Di registered with the device management table Tm and the device information acquired from the central management apparatus 131. Although not illustrated in figures, information of the installation place is also stored in the device management table Tm.

When it is determined that the installation place is different (Yes in S1611), the monitoring controller 405 proceeds to S1608.

When the determination result in S1607, S1610, or S1611 is Yes, the monitoring controller 405 transmits a request for change of device information to the slave monitoring apparatus that monitors the monitoring device Di in S1608.

Next, in S1609, in order to check if the change in the device information affects the monitoring status, the monitoring controller 405 requests the slave monitoring apparatus that monitors the monitoring device Di for a communication test of the monitoring device Di. In the case where an error has occurred in the communication test, the processing in S1302 of FIG. 11A1 of the main flow of the master monitoring apparatus is performed. After the processing of S1609, the monitoring controller 405 proceeds to S1618.

When it is determined in S1611 that the installation place is the same (No in S1611), the monitoring controller 405 directly proceeds to S1618.

When it is determined in S1605 that the device information corresponding to the device ID of the monitoring device Di is not registered with the device management table Tm (No in S1605), the monitoring controller 405 proceeds to S1612.

In S1612, the monitoring controller 405 newly registers the device Di with the device management table Tm.

In S1613, the monitoring controller 405 identifies the slave monitoring apparatus that monitors the monitoring device Di, based on the device information of the monitoring device Di. Specifically, the monitoring controller 405 acquires the slave monitoring apparatus that holds the monitoring apparatus ID included in the device information of the monitoring device Di acquired from the central management apparatus 131, based on the slave monitoring apparatus management table Ts. In the case where a plurality of slave monitoring apparatuses are acquired, the monitoring controller 405 performs the subsequent processing (S1614 to S1617) for the plurality of slave monitoring apparatuses.

After the processing of S1613, the monitoring controller 405 refers to the slave monitoring apparatus management table Is to acquire the IP address of the identified slave monitoring apparatus in S1614.

Next, in S1615, the monitoring controller 405 determines whether or not information which is able to identify the communication address such as the IP address/host name as device information of the monitoring device Di is specified (set). When it is determined that a communication address such as the IP address/host name is specified as device information of the monitoring device Di (Yes in S1615), the monitoring controller 405 proceeds to S1616.

In S1616, the monitoring controller 405 transmits an individual search request to the slave monitoring apparatus identified by the IP address or the like acquired in S1614. At least the IP address/host name and the serial number/MAC address which are specified as the device information of the search device (the monitoring device Di) are added to the request. After the processing of S1616, the monitoring controller 405 proceeds to S1618.

Meanwhile, when it is determined in S1615 that the communication address such as the IP address/host name is not specified as the device information of the monitoring device Di (No in S1615), the monitoring controller 405 proceeds to S1617.

In S1617, the monitoring controller 405 transmits a full search request to the slave monitoring apparatus that is identified by the IP address or the like acquired in S1614. At least the serial number/MAC address of the search device is added to the request. After the processing of S1617, the monitoring controller 405 proceeds to S1618.

After S1609, when the determination result in S1611 is No, after S1616, or after 1617, the monitoring controller 405 increments i by one in S1618. When i is smaller than N, the monitoring controller 405 proceeds to S1604, and processing is performed for the next monitoring device Di. Meanwhile, i is equal to N (processing for i=N−1 is finished, that is, processing for all the monitoring devices is finished), the monitoring controller 405 ends the device information change confirmation processing.

As described above, according to the first embodiment, in accordance with detection of an error with a possibility of movement of a monitoring target device in slave device monitoring, device search processing is performed by another slave monitoring apparatus. When a new device is detected, the slave monitoring apparatus immediately starts monitoring. Therefore, the movement of the monitoring device may be detected quickly, and an effect of shortening the monitoring stop time may be achieved. Furthermore, in the case where a missing device is not found for a certain period of time, registration from the slave monitoring apparatus is deleted. Therefore, an effect of reducing the processing load of the monitoring processing by the slave monitoring apparatus and the communication load with the device may be achieved. Furthermore, since the master monitoring apparatus performs transmission to the central management apparatus after registration is deleted from the slave monitoring apparatus, an effect of reducing the overall processing load may be achieved.

Accordingly, the monitoring stop time at the time when the monitoring target device is moved may be reduced, and monitoring of the device may be resumed. In addition, an unwanted/unnecessary change of the monitoring apparatus may be suppressed.

### Second Embodiment

In the first embodiment, an example in which a master monitoring apparatus transmits a search instruction to a slave monitoring apparatus when the slave monitoring apparatuses 101 and 111 detect various errors such as communication inability of devices that the slave monitoring apparatuses 101 and 111 are monitoring during regular processing and notify the master monitoring apparatus 121 of the error, is described. In accordance with detection of a new device by a new slave monitoring apparatus before the original slave monitoring apparatus detects an error, movement of a monitoring target device may be found. Furthermore, the detected device may not move between monitoring apparatuses, and a new device may move between the monitoring apparatuses. In the case of a new device, device information may not be reflected in the master monitoring apparatus 121 at the time when the new device is detected, depending on the timing at which information is acquired from the central management apparatus 131. In this case, a determination is to be made by a method (1) of updating a missing device list in the first embodiment based on information of the central management apparatus 131 or a method (2) of acquiring all the latest registration device information from the central management apparatus 131 and determining whether the acquired registration device information is present in the monitoring target lists for all the monitoring devices. In the second embodiment, the method (2) will be described with reference to FIGS. 17, 18, and 19.

First, processing by the slave monitoring apparatuses 101 and 111 will be described with reference to FIGS. 17 and 18.

FIG. 17 is a flowchart illustrating regular search processing performed by the slave monitoring apparatuses 101 and 111 in the second embodiment. This processing is performed in S807 of FIG. 8A. The processing of individual steps illustrated in the flowcharts of FIGS. 17 and 18 are implemented when the CPU 201 provided in a slave monitoring apparatus reads and executes a control program according to an embodiment of the present invention stored in a nonvolatile storage device such as the ROM 202 or the HD 205. Furthermore, unless otherwise stated, the processing is mainly operated by the monitoring controller 507 in cooperation with other units as necessary. In the slave monitoring apparatus according to the second embodiment, the regular search processing is regularly performed by setting a regular search task as well as an instruction by the master monitoring apparatus.

First, in S1201, the monitoring controller 507 performs full search processing within the monitoring area of the slave monitoring apparatus. As in the first embodiment, the full search is executed within the monitoring area by broadcasting/multicasting in accordance with preset address specification.

Next, in S1202, the monitoring controller 507 determines whether or not a new device is included in devices found in S1201. When it is determined that a new device is present (Yes in S1202), the monitoring controller 507 proceeds to S1203.

In S1203, the monitoring controller 507 performs device registration processing for the found new device. The device registration processing will be described in detail with reference to FIG. 18. FIG. 18 will be described later. After the processing of S1203, the monitoring controller 507 proceeds to S1202.

Meanwhile, when it is determined that a new device is not present (No in S1202), the monitoring controller 507 ends the regular search processing.

FIG. 18 is a flowchart illustrating the details of device registration processing according to the second embodiment. The device registration processing illustrated in FIG. 18 is mostly similar to the device registration processing according to the first embodiment illustrated in FIG. 10. Only differences from FIG. 10 will be described below. Although FIG. 10 illustrates an example corresponding to processing for the case where a missing device list is acquired from the master monitoring apparatus 121, FIG. 18 illustrates an example corresponding to processing for the case where a monitoring target device list is acquired. Hereinafter, the details of the device registration processing illustrated in FIG. 18 will be described.

First, since processing of S1101 to S1103 is the same as the processing of S1001 to S1003 in FIG. 10, explanation for the processing of S1101 to S1103 will be omitted. After the processing of S1103 or when the determination result in S1102 is No, the monitoring controller 507 proceeds to S1104.

In S1104, the monitoring controller 507 requests the management information acquisition unit 508 for acquisition of a monitoring target device list from the master monitoring apparatus 121. In response to the request, the management information acquisition unit 508 acquires the monitoring target device list from the master monitoring apparatus 121.

Next, in S1105, the monitoring controller 507 determines whether or not a registration target device (device A) is included in the monitoring target device list. When it is determined that the registration target device (device A) is included in the monitoring target device list (Yes in S1105), the monitoring controller 507 proceeds to S1106. The processing of S1106 and later processing are the same as the processing of S1006 and later processing in FIG. 10. Therefore, explanation for the processing of S1106 and later processing will be omitted.

Meanwhile, when it is determined that the registration target device (device A) is not included in the monitoring target device list (No in S1105), the monitoring controller 507 ends the device monitoring registration processing.

Next, processing by the master monitoring apparatus 121 according to the second embodiment will be described.

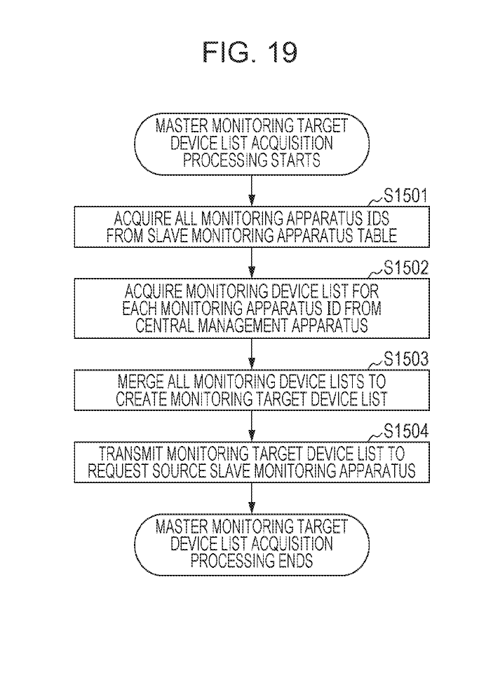

FIG. 11B is a flowchart obtained by extracting parts relevant to the second embodiment from the main flow of the master monitoring apparatus. Processing of individual steps illustrated in flowcharts of FIG. 11B and FIG. 19 is implemented when the CPU 201 provided in the master monitoring apparatus 121 reads and executes a control program according to an embodiment of the present invention stored in a nonvolatile storage device such as the ROM 202 or the HD 205. Furthermore, in the flowcharts, only processing relevant to the present invention will be explained. Since processing not relevant to the present invention is different from the essence of the present invention, explanation for that processing will be omitted. In addition, unless otherwise stated, the processing is mainly operated by the monitoring controller 405 in cooperation with other units as necessary.

In the second embodiment, when the determination result in S1326 of FIG. 11A1 is No, the monitoring controller 405 proceeds to S1328 of FIG. 11B.

In S1328, the monitoring controller 405 determines whether or not a monitoring target device list acquisition request from a slave monitoring apparatus is detected (whether or not a monitoring target device list acquisition request from a slave monitoring apparatus is received). When it is determined that the monitoring target device list acquisition request from the slave monitoring apparatus is detected (Yes in S1328), the monitoring controller 405 proceeds to S1329.

In S1329, the monitoring controller 405 performs monitoring target device list acquisition processing. The monitoring target device list acquisition processing will be described with reference to FIG. 19. After the processing of S1329, the monitoring controller 405 proceeds to S1302 of FIG. 11A1.

Meanwhile, when it is determined in S1328 that the monitoring target device list acquisition request from the slave monitoring apparatus is not detected (No in S1328), the monitoring controller 405 directly proceeds to S1302 of FIG. 11A1 in the second embodiment.

FIG. 19 is a flowchart illustrating monitoring target device list acquisition processing of S1329 in FIG. 11B.

First, in S1501, the monitoring controller 405 acquires all the monitoring apparatus IDs from the slave monitoring apparatus management table Ts.

Next, in S1502, the monitoring controller 405 acquires a monitoring target device list for each monitoring apparatus ID from the central management apparatus 131. At least device identification information for identifying each monitoring device is included in the monitoring target device list.

Next, in S1503, the monitoring controller 405 merges the monitoring target device lists acquired in S1502 to create a monitoring target device list.

Next, in S1504, the monitoring controller 405 transmits the monitoring target device list to the request source slave monitoring apparatus, and ends the monitoring target device list acquisition processing.

As described above, in the second embodiment, a slave monitoring apparatus refers to the latest monitoring target device list before starting monitoring of a device at the time of regular processing or the like to determine permission or inhibition of registration. Therefore, the monitoring stop time may further be shortened, and the processing delay may be reduced.

### Third Embodiment

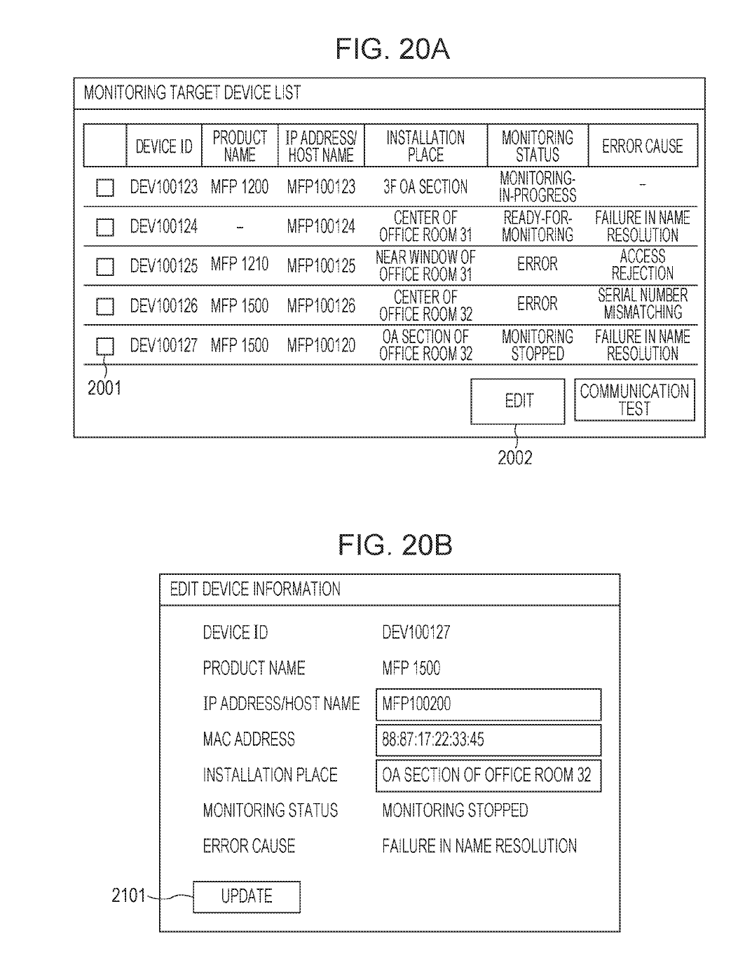

In the first and second embodiments described above, an example in which movement of a monitoring target device is determined by processing by the slave monitoring apparatuses 101 and 111 has been explained. In addition to the configurations of the first and second embodiments, a monitoring target device for the master monitoring apparatus 121 may be displayed on a user interface (UI) so that a user can change settings through the UI. With this configuration, movement of the monitoring target device may be found by detecting a setting change instruction through the UI. In the third embodiment, such a case will be described with reference to FIGS. 20A and 20B and FIG. 11C.

FIGS. 20A and 20B are diagrams illustrating a user interface (UI) of the master monitoring apparatus 121 according to the third embodiment. The UI illustrated in FIGS. 20A and 20B is displayed on a display of a host terminal, which is not illustrated in figures, for example, under the main control of the monitoring controller 405 by access to the master monitoring apparatus 121 from the host terminal or the like.

FIG. 20A is a diagram illustrating a user interface (UI) which illustrates a list of all the monitoring devices that the master monitoring apparatus 121 according to the third embodiment monitors.

In the example illustrated in FIG. 20A, due to limited space in the figure, there are a small number of devices. However, the actual UI is configured such that several thousands to several ten thousands monitoring devices may be browsed. When a large number of monitoring devices are displayed, since the number of devices displayed on a single screen is limited, the monitoring devices are displayed over multiple pages or by transition to a different screen. On the UI, by checking a checkbox 2001 on the left side of a device to be edited and depressing an edit button 2002, a device information edit screen illustrated in FIG. 20B may be displayed.

FIG. 20B is a diagram illustrating a device information edit screen of the device selected through the UI of FIG. 20A.

On the screen illustrated in FIG. 20B, an IP address/host name, a MAC address, and an installation place may be edited. On this screen, the IP address and the host name are treated as a single item, and a determination of whether an IP address or a host name has been input is made inside the master monitoring apparatus 121. However, an IP address and a host name may be individually arranged on the UI as different items.

In the case where the IP address/host name or the installation place is changed through the device information edit screen, there is a possibility that the installation place of the device may have been moved, and therefore movement between slave monitoring apparatuses may be required. When an update button 2101 is pressed on the device information edit screen, if device information is updated, the master monitoring apparatus 121 determines that update of device information has been made in S1330 illustrated in FIG. 11C, which will be described later. Hereinafter, FIG. 11C will be described.

FIG. 11C is a flowchart obtained by extracting parts relevant to the third embodiment from the main flow of the master monitoring apparatus. Processing of individual steps illustrated in the flowchart of FIG. 11C is implemented when the CPU 201 provided in the master monitoring apparatus 121 reads and executes a control program according to an embodiment of the present invention stored in a nonvolatile storage device such as the ROM 202 or the HD 205. Furthermore, in the flowchart, only processing relevant to the present invention will be explained. Since processing not relevant to the present invention is different from the essence of the present invention, explanation for that processing will be omitted. In addition, unless otherwise stated, the processing is mainly operated by the monitoring controller 405 in cooperation with other units as necessary.

In the third embodiment, when the determination result in S1328 of FIG. 11B is No, the monitoring controller 405 proceeds to S1330 of FIG. 11C.

In S1330, the monitoring controller 405 determines whether or not device information is updated through the UI illustrated in FIGS. 20A and 20B or the like. When it is determined that device information is changed (Yes in S1330), the monitoring controller 405 proceeds to S1331.

In S1331, the monitoring controller 405 determines whether or not the IP address/host name is changed. When it is determined that at least one of the IP address and the host name is changed (Yes in S1331), the monitoring controller 405 proceeds to S1332.

Meanwhile, when it is determined that neither the IP address nor the host name is changed (No in S1331), the monitoring controller 405 proceeds to S1334.

In S1334, the monitoring controller 405 determines whether or not the installation place is changed. When it is determined that the installation place is changed (Yes in S1334), the monitoring controller 405 proceeds to S1332.

When the determination result in S1331 is Yes or the determination result in S1334 is Yes, the monitoring controller 405 notifies the slave monitoring apparatus that monitors the device whose settings are changed of a device information change request, by referring to the device management table Tm and the slave monitoring apparatus management table Ts, in S1332.

Next, in S1333, the monitoring controller 405 requests the slave monitoring apparatus for the changed device for a communication test for the target device, and proceeds to S1302 of FIG. 11A1.

When it is determined in S1334 that the installation place is not changed (No in S1334), the monitoring controller 405 directly proceeds to S1302 of FIG. 11A1.

Furthermore, when it is determined in S1330 that device information is not changed (No in S1330), the monitoring controller 405 directly proceeds to S1302 of FIG. 11A1.

As described above, according to the third embodiment, by updating settings through the UI of the master monitoring apparatus 121, movement of a device may be detected. Accordingly, the monitoring stop time may further be shortened, and the processing delay may be reduced.

As described above, in the device management system (140 or the like) which includes the master monitoring apparatus 121 and multiple slave monitoring apparatuses, the monitoring stop time at the time when a monitoring target device is moved may be reduced, and device monitoring may be resumed. In addition, an unwanted/unnecessary change of a monitoring apparatus may be reduced.

As described above, a device (network device) according to the foregoing embodiments is not limited to an image forming device such as a copying machine, a printer, a scanner, or a multifunction device. The device may be a computer, a digital medical device, a network camera, a network home electronic appliance, a robot, or the like. In this case, by monitoring processing with a slave monitoring apparatus, monitoring information to be notified to the central management apparatus 131 from the slave monitoring apparatus is changed to information which corresponds to the device that the slave monitoring apparatus monitors.

The configuration and contents of the various data described above are not limited to the above description. It is obvious that various configurations and contents may be possible according to uses and purposes. Furthermore, a combination of the forgoing embodiments may also be included in the present invention.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-010086, filed Jan. 22, 2015 which is hereby incorporated by reference herein in its entirety.

What is claimed is:

1. An apparatus as a third apparatus in a system which includes a first apparatus, a second apparatus for monitoring network devices and communicate with a central management apparatus via a network, the apparatus comprising:
a reception unit configured to receive a search request, in accordance with a state in which a network device as a monitoring target of the second apparatus has become unable to be monitored, from the first apparatus, which manages the second apparatus and the third apparatus;
an execution unit configured to execute search processing for a network as a monitoring target of the third apparatus in accordance with the reception of the search request;
a registration unit configured to register the network device as a monitoring target when the network device which has become unable to be monitored is found in accordance with the executed search processing;
a monitoring unit configured to start monitoring processing for the network device in accordance with the registration of the network device;
a notification unit configured to notify the first apparatus of the registration of the network device after the monitoring processing is started; and
a transmission unit configured to transmit a result of the monitoring of the network device as the monitoring target to the central management apparatus.

2. The apparatus according to claim 1, wherein the search processing is executed using a host name of the network device which has become unable to be monitored.

3. The apparatus according to claim 1, wherein the execution unit regularly acquires a list of network devices set as monitoring targets by the central management apparatus and executes search processing for a network device included in the list.

4. The apparatus according to claim 1, wherein the reception unit receives a search request, in accordance with a state in which settings of a network device have been changed, from the first apparatus.

5. The apparatus according to claim 1, wherein in a case where at least one of errors of a failure in name resolution, mismatching of registered address information, and a failure in a communication test continues for a time exceeding a predetermined time, it is determined that a network device is unable to be monitored.

6. The apparatus according to claim 1, wherein a result of the monitoring includes at least one of information regarding a failure, counter information, and log information.

7. The apparatus according to claim 1, wherein the network device includes at least one of a copying machine, a printer, a scanner, a computer, a digital medical device, a network camera, a network home electronic appliance, and a robot.

8. A system comprising:
a first apparatus;
a second apparatus; and
a third apparatus, the first apparatus, the second apparatus, and the third apparatus being able to monitor network devices and communicate with a central management apparatus via a network,
wherein the third apparatus includes
a reception unit configured to receive a search request, in accordance with a state in which a network device as a monitoring target of the second apparatus has become unable to be monitored, from the first apparatus, which manages the second apparatus and the third apparatus,
an execution unit configured to execute search processing for a network as a monitoring target of the third apparatus in accordance with the reception of the search request,
a registration unit configured to register the network device as a monitoring target when the network device which has become unable to be monitored is found in accordance with the executed search processing,
a monitoring unit configured to start monitoring processing for the network device in accordance with the registration of the network device,
a notification unit configured to notify the first apparatus of the registration of the network device after the monitoring processing is started, and
a transmission unit configured to transmit a result of the monitoring of the network device as the monitoring target to the central management apparatus, and
wherein the first apparatus includes
a first request unit configured to transmit a search request for the network device to the third apparatus, in accordance with the state in which the network device as the monitoring target of the second apparatus has become unable to be monitored.

9. The system according to claim 8,
wherein the first apparatus includes a second request unit configured to transmit a request to delete the network device from the monitoring target, in accordance with the state in which the network device as the monitoring target of the second apparatus has become unable to be monitored, to the second apparatus.

10. The system according to claim 8, wherein the first request unit regularly transmits a search request for the network device which is unable to be monitored, to the third apparatus.

11. The system according to claim 8, wherein the search processing is executed using a host name of the network device which has become unable to be monitored.

12. The system according to claim 8, wherein the execution unit regularly acquires a list of network devices set as monitoring targets by the central management apparatus and executes search processing for a network device included in the list.

13. The system according to claim 8, wherein the reception unit receives a search request, in accordance with a state in which settings of a network device have been changed, from the first apparatus.

14. The system according to claim 8, wherein in a case where at least one of errors of a failure in name resolution, mismatching of registered address information, and a failure in a communication test continues for a time exceeding a predetermined time, it is determined that a network device is unable to be monitored.

15. The system according to claim 8, wherein a result of the monitoring includes at least one of information regarding a failure, counter information, and log information.

16. The system according to claim 8, wherein the network device includes at least one of a copying machine, a printer, a scanner, a computer, a digital medical device, a network camera, a network home electronic appliance, and a robot.

17. A method for a third apparatus in a system which includes a first apparatus, a second apparatus to monitor network devices and communicate with a central management apparatus via a network, the method comprising:
receiving a search request, in accordance with a state in which a network device as a monitoring target of the second apparatus has become unable to be monitored, from the first apparatus, which manages the second apparatus and the third apparatus;
executing search processing for a network as a monitoring target of the third apparatus in accordance with the reception of the search request;
registering the network device as a monitoring target when the network device which has become unable to be monitored is found in accordance with the executed search processing;
starting monitoring processing for the network device in accordance with the registration of the network device;
notifying the first apparatus of the registration of the network device after the monitoring processing is started; and
transmitting a result of the monitoring of the network device as the monitoring target to the central management apparatus.

18. A method for a system which includes a first apparatus, a second apparatus, and a third apparatus for monitoring network devices and communicate with a central management apparatus via a network, the method comprising:
receiving, with the third apparatus, a search request, in accordance with a state in which a network device as a monitoring target of the second apparatus has become unable to be monitored, from the first apparatus, which manages the second apparatus and the third apparatus;
executing, with the third apparatus, search processing for a network as a monitoring target of the third apparatus in accordance with the reception of the search request;
registering, with the third apparatus, the network device as a monitoring target when the network device which has become unable to be monitored is found in accordance with the executed search processing;
starting, with the third apparatus, monitoring processing for the network device in accordance with the registration of the network device;
notifying, with the third apparatus, the first apparatus of the registration of the network device after the monitoring processing is started;
transmitting, with the third apparatus, a result of the monitoring of the network device as the monitoring target to the central management apparatus; and
transmitting, with the first apparatus, a search request for the network device to the third apparatus, in accordance with the state in which the network device as the monitoring target of the second apparatus has become unable to be monitored.
